(19) United States
(12) Patent Application Publication
(10) Pub. No.: US 2024/0311703 A1
(43) Pub. Date: Sep. 19, 2024

(54) HELLINGER DECISION TREES FOR FRAUD DETECTION

(71) Applicant: KBC Global Services NV, Brussels (BE)

(72) Inventors: Carlos Ortega Vázquez, Leuven (BE); Jochen De Weerdt, Leuven (BE); Seppe vanden Broucke, Lede (BE); Barak Chizi, Woluwe-Saint-Pierre (BE); Michaël Mariën, Bertem (BE); Dimitar Yaprakov, Wemmel (BE); Jeroen D’Haen, Temse (BE)

(21) Appl. No.: 18/129,801

(22) Filed: Mar. 31, 2023

Related U.S. Application Data
(60) Provisional application No. 63/451,907, filed on Mar. 13, 2023.

(51) Int. Cl. G06N 20/20

(52) U.S. Cl. CPC G06N 20/20

(57) ABSTRACT

A Hellinger decision tree can detect fraudulent transactions in a data set of financial transactions. Applying the Hellinger decision tree uses a Hellinger distance. The Hellinger decision tree can be part of a machine learning algorithm. In an example, the Hellinger decision tree is a positive and unbalanced Hellinger decision tree used with an imbalanced positive and unlabeled data.

### CROSS-REFERENCE TO RELATED APPLICATIONS

This application claims priority to the provisional patent application filed Mar. 13, 2023 and assigned U.S. App. No. 63/451,907, the disclosure of which is hereby incorporated by reference.

### FIELD OF THE DISCLOSURE

This disclosure relates to machine learning and, more particularly, to machine learning for fraud detection.

### BACKGROUND OF THE DISCLOSURE

Despite the ubiquity of supervised learning in practice, many real-world applications, including fraud detection, text classification, and medical diagnosis suffer from inaccurate or incomplete label information. Moreover, these applications are often also characterized by a high class imbalance. These applications relate to two areas of research: positive and unlabeled (PU) learning and imbalanced learning. In these applications, the underrepresented class is the class of interest (i.e., positive class). In fraud detection, the fraudulent cases represent less than one percent of the total transactions. Despite a less severe class imbalance in medical diagnosis, the false negatives (i.e., undetected tumor) are more important than false positives. The underrepresentation of the minority class can become more challenging with the issue of incomplete label information. In the medical data, only positive information is often reported (i.e., diagnosed disease). In fraud detection, only a few fraudsters are identified whereas most of them go unnoticed. Thus, some applications can benefit from the connection between PU learning and imbalanced learning. PU learning assumes that labeled examples are positive, but unlabeled examples can belong to either the positive or negative class. Imbalanced learning aims to propose methods that handle settings in which the class distribution is significantly unequal. Improved systems and techniques that focus on learning from imbalanced data sets in which the negative class and a proportion of positives remain unlabeled are needed.

PU learning has increasingly gained popularity in recent years, as demonstrated by the increase in method development. One approach that was first used in text classification identifies reliable negatives and learns from positives and the resulting reliable negatives. Another approach assumed that all unlabeled examples are negative and applied standard classifiers. A later approach utilized the class prior (i.e., positive class ratio) in existing algorithms to enable PU learning.

Non-standard settings in PU learning motivated by domain applications were explored. For example, a common assumption in PU learning is that the labeled examples are a random subset of the positive examples. However, this assumption is often violated in practice. Although most modern PU methods perform successfully in several benchmark data sets, it remains unclear how well they perform in highly imbalanced data sets.

Imbalanced PU classification poses new challenges that have not been sufficiently addressed. In this specific setting, the fact that only a few positive instances are known to the learner creates more severe class imbalance. A suitable PU method for an imbalanced setting should be able to exploit the small number of labeled positives and still learn from unlabeled instances.

Little work has focused on imbalanced PU classification. PU learning via optimizing an adaptation of the area under the receiver operating characteristic curve (ROC-AUC) for the semisupervised setting was proposed. However, optimizing the ROC-AUC does not guarantee optimization of more relevant metrics for imbalanced classification, such as the area under the precision-recall curve. Cost-Sensitive Positive and Unlabeled learning (CSPU) also was proposed, which introduced the use of misclassification costs to address class imbalance. CSPU's requirement to have misclassification costs available is not easily met given that in several domains these costs are difficult to determine. Lastly, the imbalanced nonnegative PU learning method relies on oversampling to balance the PU data. Nonetheless, oversampling might cause unnecessary overfitting, and the oversampling rate might need to be tuned as an extra hyper-parameter. Accordingly, there is a need for a technique that can perform well in highly imbalanced PU data without requiring resampling or misclassification costs.

Fraud detection is a challenging task for machine learning algorithms because of severe class imbalance and incomplete label information. In many fraud detection applications, the fraudulent instances represent less than 1% of the total examples. Moreover, inaccurate label information can become an issue if the fraudsters are systematically successful in hiding from current detection systems. For instance, in a study on car insurance fraud in Quebec, claim adjusters could only discover one-third of all possible fraudsters. This setting is referred to as positive and unlabeled data because a subset of fraudsters is discovered.

Learning from positive and unlabeled data, or PU learning, is the setting in which a binary classifier can only train from positive and unlabeled instances, the latter containing both positive as well as negative instances. Many PU applications (e.g., fraud detection) are also characterized by class imbalance, which creates a challenging setting. Not only are fewer minority class examples compared to the case where all labels are known, there is also only a small fraction of unlabeled observations that would actually be positive. Despite the relevance of the topic, only a few studies have considered a class imbalance setting in PU learning. Thus, improved systems and techniques are needed, specifically for fraud detection.

### SUMMARY OF THE DISCLOSURE

The present disclosure provides a technique that can directly handle imbalanced PU data, named the PU Hellinger Decision Tree (PU-HDT). The present disclosure exploits the class prior to estimate the counts of positives and negatives in every node in the tree. Moreover, the Hellinger distance is used instead of more conventional splitting criteria because it has been shown to be class-imbalance insensitive. This adaptation allows PU-HDT to perform well in highly imbalanced PU data sets.

The present disclosure also provides PU Stratified Hellinger Random Forest (PU-SHRF), which uses PU-HDT as its base learner and integrates a stratified bootstrap sampling. PU-SHRF may substantially outperform state-of-the-art PU learning methods for imbalanced data sets in most experimental settings.

The present disclosure also provides a tree-based technique that is designed to learn from imbalanced PU data, denoted as the PU-HDT. PU-HDT does not need to modify the imbalanced data distribution. In this class-prior based method, PU-HDT exploits the class prior (i.e., the proportion of positive examples) to enable PU learning. At each node, the true positives are estimated from unlabeled instances rather than assuming that all unlabeled instances are negatives. Instead of using a traditional splitting criterion exhibiting demonstrated inferiority towards imbalanced data sets (e.g., Gini and entropy), PU-HDT uses the Hellinger distance. The Hellinger distance has shown robustness to extreme degrees of class imbalance in previous studies. These two improvements enable PU-HDT to handle highly imbalanced data sets effectively. The performance of PU-HDT can be further improved using an ensemble.

The present disclosure demonstrates that a modified random forest with PU-HDT as its base learner outperforms state-of-the-art PU learning methods under different experimental settings with class imbalance.

Additionally, an ensemble method that uses PU-HDT as the base learner is presented.

In an embodiment, a method of fraud detection includes receiving, at a processor, a data set of financial transactions. A Hellinger decision tree is applied, using the processor, to detect fraudulent transactions in the data set of financial transactions. A Hellinger distance is used as part of the applying.

The Hellinger decision tree can be part of a machine learning algorithm.

The Hellinger decision tree can be configured to capture divergence between positive and negative class distribution without being dominated by class imbalance.

The Hellinger decision tree can be configured to use class prior to estimate counts of positives and negatives in each node.

The method can further include limiting a size of the Hellinger decision tree after a tree node reaches a maximum height using the processor thereby avoiding overfitting.

The Hellinger decision tree can be a positive and unbalanced Hellinger decision tree. The data set of fraudulent transactions in this instance can be imbalanced positive and unlabeled data.

The method can further include receiving an estimated fraud rate at the processor prior to the applying.

The Hellinger decision tree can be used as a base learner in a modified random forest.

In an instance, the Hellinger decision tree is a positive and unbalanced Hellinger decision tree. The data set of fraudulent transactions can be an imbalanced positive and unlabeled data in this instance. The Hellinger decision tree can be configured to consider random feature selection when initializing a tree node. The Hellinger decision tree also can be configured to use a size of a stratified bootstrap sample and a class prior.

The Hellinger distance can be used to capture divergence between positive and negative class distribution.

The method can further include receiving a positive and unlabeled dataset at the processor and training the Hellinger decision tree with the positive and unlabeled dataset. The positive and unlabeled dataset can be unbalanced.

The financial transactions can be credit card transactions or insurance transactions.

A system can be configured to perform the method of the first embodiment. The system can be a computer or a server.

A non-transitory computer readable medium storing a program can be configured to instruct the processor to execute the method of the first embodiment.

### BRIEF DESCRIPTION OF THE FIGURES

For a fuller understanding of the nature and objects of the disclosure, reference should be made to the following detailed description taken in conjunction with the accompanying drawings.

FIG. 1 is a decision tree that illustrates the difference between Gini Index and Hellinger Distance in node splitting.

FIGS. 2(a)-2(d) show a class-imbalanced variant of the data set in which the class prior α=5%, the upper half-moon corresponds to the negative class, whereas the lower half-moon corresponds to the positive class, as discussed in Example 1 and Example 2.

FIGS. 3(a)-3(c) display the rank of each metric to emphasize the relative performance between methods tested in Example 2.

FIGS. 4(a)-4(c) display the rank of F1-score, ROC-AUC, and PR-AUC, as discussed in Example 2.

FIG. 5 and FIG. 6 present the results of the sensitivity analysis performed in Example 2.

FIG. 7-13 show tables with experimental results.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Machine learning can be used for fraud detection. Embodiments disclosed herein include a model that can deal with highly imbalanced PU datasets, which can occur with financial fraud detection because there may be a limited pool of positives in a large volume of unlabeled data points. Embodiments disclosed herein can handle this imbalance.

It will be understood that, while exemplary features of a method of fraud detection have been described, such an arrangement is not to be construed as limiting the invention to such features. The method may be implemented in software, firmware, hardware, or a combination thereof. In an instance, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the method of fraud detection. The processor(s) is a hardware device for executing software, particularly software stored in memory. Processor(s) can be any custom made or commercially available processor, a primary processing unit (CPU), an auxiliary processor among several processors associated with a computer, a semiconductor-based microprocessor (in the form of a microchip or chip set), a macro-processor, or generally any device for executing software instructions.

Memory is associated with the processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by the processor(s).

The software in memory may include one or more separate programs. The separate programs comprise ordered listings of executable instructions for implementing logical functions in order to implement the functions of the modules. In the example described herein, the software in memory includes the one or more components of the method and is executable on a suitable operating system (O/S).

The present disclosure may include components provided as a source program executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object-oriented programming language, which has classes of data and methods, or (b) a procedural programming language, which has routines, subroutines, and/or functions, for example but not limited to, C, C++, Pascal, Basic, Fortran, Cobol, Ped, Java, and Ada.

In an embodiment of the PU-HDT Algorithm, the Hellinger Decision Tree (HDT) exploits the Hellinger distance to improve the splitting mechanism in imbalanced settings. The Hellinger distance is used to quantify the similarity between two probability distributions. A goal of the Hellinger distance is to capture the divergence between the positive and negative class distribution without being dominated by the class imbalance. Equation (1) further illustrates the robustness to class imbalance. The Hellinger distance can be calculated in a parent node i as follows:

$$\\ \begin{matrix}{HD}_{i} = \sqrt{{( \sqrt{\frac{{N}_{{left}_{i}}}{{N}_{i}}} - \sqrt{\frac{{P}_{{left}_{i}}}{{P}_{i}}} )}^{2} + {( \sqrt{\frac{{N}_{{right}_{i}}}{{N}_{i}}} - \sqrt{\frac{{P}_{{right}_{i}}}{{P}_{i}}} )}^{2}} , & ( 1 )\end{matrix}$$

where Nᵢ and Pᵢ are the counts of negatives and positives in the parent node i, N_{left}_{ᵢ} and P_{left}_{ᵢ} are the counts of the examples that fall into the left child node, and N_{right}_{ᵢ} and P_{right}_{ᵢ} are the ones that fall into the right child node. Thus, there is no influence of the proportion of the majority class. In comparison, the Gini Index, as used in, for example, a classification and regression tree (CART), depends on pⱼ, the proportion of class j: I_{G}=1−Σⱼ₌₁²pⱼ². With the Hellinger distance, the HDT can create better splits during tree construction in imbalanced data sets.

HDT may be adapted to PU learning by exploiting the class prior, represented as α. Under the selected completely at random (SCAR) assumption, the class prior enables estimation of the label frequency c, the proportion of positive examples that are labeled in the data. Equation (2) illustrates the previous statement:

$$\\ \begin{matrix}\begin{matrix}Pr ( l = 1 ) = Pr ( l = 1 \vert y = 1 ) Pr ( y = 1 ) + Pr ( l = 1 \vert y = 0 ) Pr ( y = 0 ) \\ = Pr ( l = 1 \vert y = 1 ) Pr ( y = 1 ) \\ = c α ,\end{matrix} & ( 2 )\end{matrix}$$

where l is the observed labeled and y is the true label. The proportion of labeled positives Pr(l=1) can be estimated from the training data. In the PU setting, only the labeled instances can belong to the positive class, which implies that the conditional probability Pr(l=1|y=0)=0. The label frequency c enables the estimation of the counts of positives and negatives from PU data. In a given node i, the estimated count of positives Pt can be calculated as follows:

$$\\ \begin{matrix}{\hat{P}}_{i} = min \{ \frac{{L}_{i}}{c} , {T}_{i} \} & ( 3 )\end{matrix}$$

$$\\ {\hat{P}}_{i} = min \{ {L}_{i} \frac{α}{Pr ( l = 1 )} , {T}_{i} \} ,$$

where Lᵢ is the count of labeled positives and Tᵢ is the count of total instances in node i. Equation (3) indicates that, in a given node, the number of positives cannot exceed the total number of examples. The estimated count of negatives Nᵢ can be computed from the difference between the total count of instances and the number of positives: \hat{N}ᵢ=Tᵢ−\hat{P}ᵢ. This estimation is used to modify entropy as the splitting criterion. Moreover, Eq. (3) emphasizes the importance of the class prior for adapting the HDT to PU learning, meaning that PU-HDT may fall into the category of class-prior-based methods. Despite the relevance of the class prior in PU-HDT, it is often unavailable in PU learning, so domain knowledge or methods for class prior estimation may be needed.

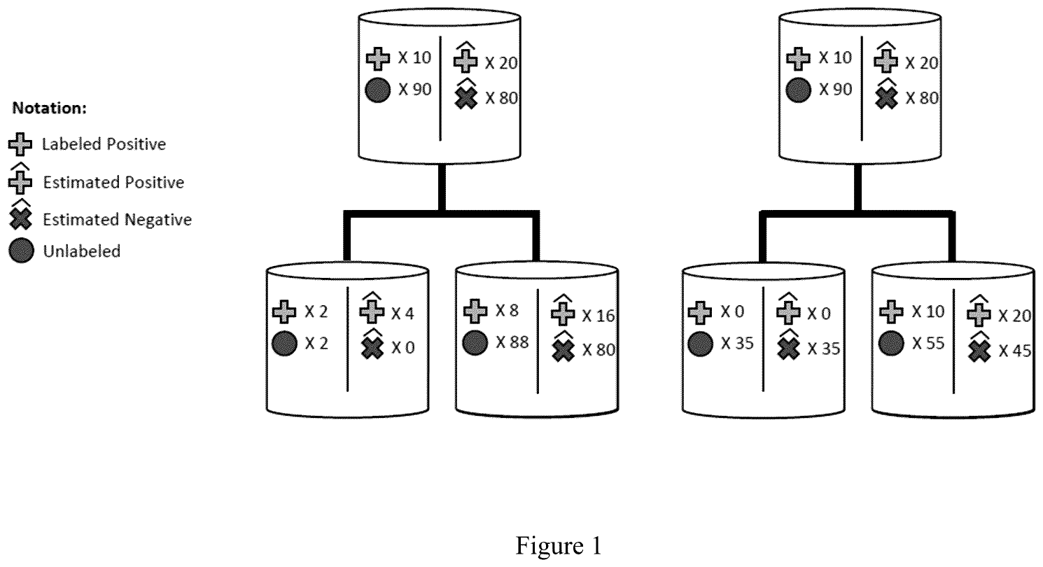

FIG. 1 illustrates the difference between Gini Index and Hellinger Distance in node splitting. The left tree is split according to the Gini Index whereas the right tree follows the Hellinger distance with the PU adaptation. As demonstrated in FIG. 1, Gini Index is better in the left tree (0.166) compared to the right tree (0.169), and PU Hellinger distance is better in the right tree (0.707) than in the left tree (0.459).

Algorithm 1 demonstrates how a PU-HDT is built based on the Hellinger Distance with the estimated counts of positive and negative instances. PU-HDT follows the same binary tree construction as other decision trees known in the art, such as CART and HDT. Algorithm 1 may also limit the size of the tree to avoid overfitting if it is used as a stand-alone classifier. In case that there is a small pool of labeled data, the PU-HDT can perform hyperparameter tuning of the size of the tree.

In an embodiment using PU-HDT in a bagging ensemble or Random Forest, the tree may fully grow, as overfitting is no longer an issue. Algorithm 1 first creates a tree node n. Given its recursive aspect, if the tree node n reaches the maximum height h, then the algorithm stops. After the creation of the tree node n, a random selection of features fₛₑₗ can be optionally obtained for the tree node n. However, a standard decision tree does not implement any random feature selection: FX and fₛₑₗ are the same set. Then, the optimal split value x*_{fmax} may be found through a search within the set of features fₛₑₗ, wherein the optimal split value is the one that maximizes the PU Hellinger distance. Afterward, the training instances, shown as features and label (X, L), are divided into two subsets (X_{left}, L_{left}; X_{right}, L_{right}) depending on the position of the instance in x_{fmax} with regards to the optimal split value x*_{fmax}. Finally, for each subset, a new tree node (n.left and n.right) may be created to iterate the procedure again. FIG. 1 demonstrates a scenario showing the advantage of the (PU-)Hellinger distance over the Gini Index. As previously explained, the Gini Index prefers a node split (left tree) that concentrates most of the positive and negative class in one single child node, and the (PU-)Hellinger distance indicates a preference for a node split (right tree) that concentrates all the positives in one child node.

Algorithm 1: PU-HDT(X, L, α, h, ϕ)

Input: X - data, L - labels, α - class prior, h - depth, ϕ - number of

considered features at each split

| | Output: PU-HDT - Hellinger Decision Tree for PU learning | | |
|---|---|---|---|
| 1 | create a tree node n | | |
| 2 | Initialize e ← 0 | | |
| 3 | if e > h then | | |
| 4 | \| | return | |
| 5 | else | | |
| 6 | \| | e+= 1 | |
| 7 | end | | |
| 8 | let F_{X} be the set of features from input X | | |
| 9 | fₛₑₗ ← RandomSample (Fₓ, ϕ) | | |
| 10 | fₘₐₓ ← argmax_{f∈f}_{ₛₑₗ} PUHellingerDistance (X, f) | | |
| 11 | let x_{f}_{ₘₐₓ}* be the optimal split value in feature fₘₐₓ | | |
| 12 | split X into X_{left}(x_{f}_{ₘₐₓ} < x_{f}_{ₘₐₓ}*) and X_{right}(x_{f}_{ₘₐₓ} ≥ x_{f}_{ₘₐₓ}*) | | |
| 13 | split L into L_{left}(x_{f}_{ₘₐₓ} < x_{f}_{ₘₐₓ}*) and L_{right}(x_{f}_{ₘₐₓ} ≥ x_{f}_{ₘₐₓ}*) | | |
| 14 | n.left ← PU-HDT (X_{left}, L_{left}, h, ϕ) | | |
| 15 | n.right ← PU-HDT (X_{right}, L_{right}, h, ϕ) | | |
| 16 | Function PUHellingerDistance (X, f): | | |
| 17 | \| | Initalize BestHellingerDistance ← −1 | |
| 18 | \| | let V_{f} be the set of values of feature f | |
| 19 | \| | for each value v ∈ V_{f} do | |
| 20 | \| | \| | w ← V_{f}\v |
| 21 | \| | \| | estimate \hat{P}_{f,v}, \hat{N}_{f,v}, \hat{P}_{f,w}, and \hat{N}_{f,w} according to Eq. (3) |
| 22 | \| | \| | \hat{P} ← \hat{P}_{f,v} + \hat{P}_{f,w} |
| 23 | \| | \| | \hat{N} ← \hat{N}_{f,v} + \hat{N}_{f,w} |
| 24 | \| | \| | HD ← (\sqrt{\hat{N}_{f,v}/\hat{N}} − \sqrt{\hat{P}_{f,v}/\hat{P}})² + (\sqrt{\hat{N}_{f,w}/\hat{N}} − \sqrt{\hat{P}_{f,w}/\hat{P}})² |
| 25 | \| | \| | if HD > BestHellingerDistance then |
| 26 | \| | \| | \| BestHellingerDistance ← HD |
| 27 | \| | \| | end |

| | | |
|---|---|---|
| 28 | \| | end |

| | |
|---|---|
| 29 | return \sqrt{BestHellingerDistance} |

Ensemble learning generally improves the performance of a single learner by training several base learners and combining their output. An ensemble method is Random Forest (Breiman 2001, the relevant portions of which are incorporated by reference), which extends bagging by incorporating randomized feature selection with the base learner being a decision tree. In an embodiment PU-HDT may be used as the base learner in a Random Forest. Moreover, the ensemble algorithm may be further modified based on the insights from PU Bagging (Mordelet & Vert 2014, the relevant portions of which are incorporated by reference). PU Bagging is suitable for imbalanced learning because each bootstrap sample includes all the available labeled positives, and a subsample of the unlabeled data so that a balanced training set can be achieved. Although PU-HDT can handle imbalanced data, there is a practical reason to obtain bootstrap samples from the unlabeled data.

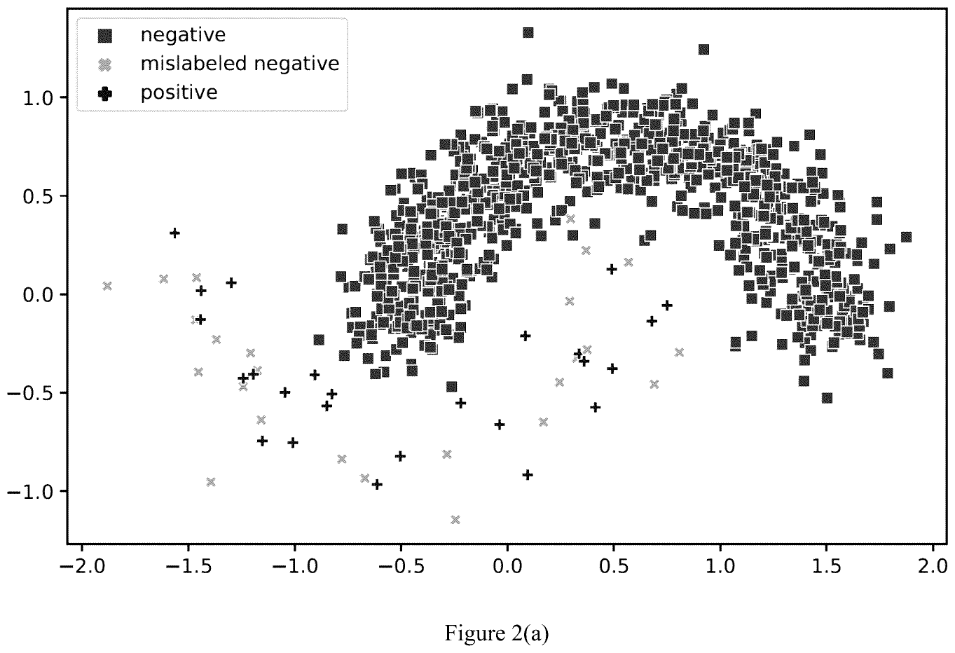

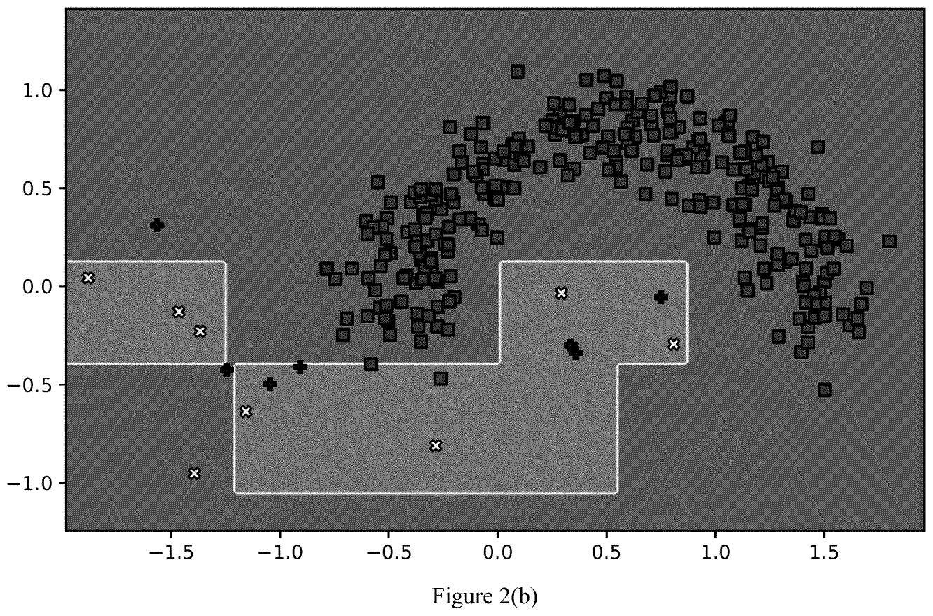

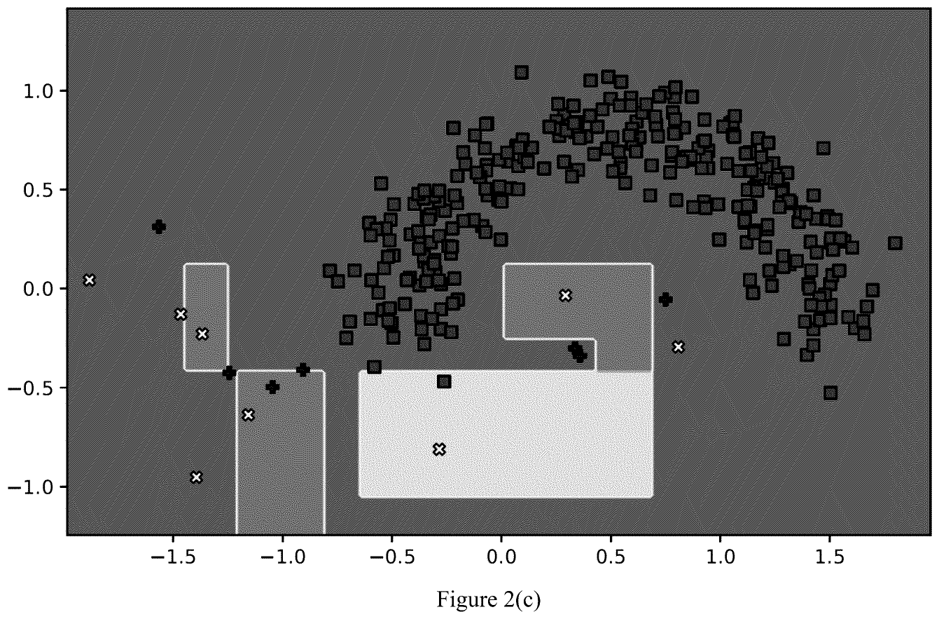

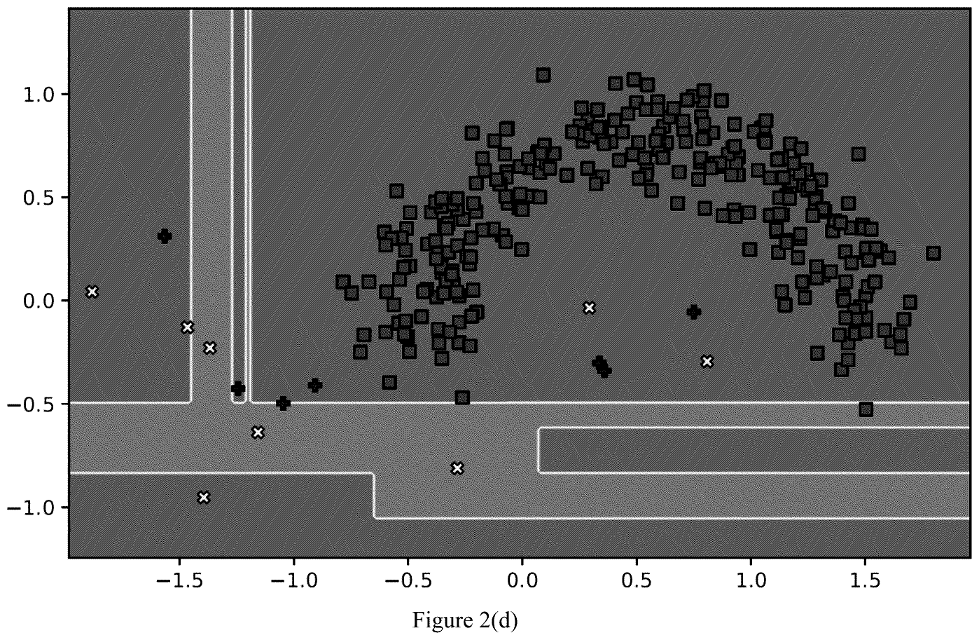

The capability of PU-HDT to learn from PU data may be hindered by a bootstrap sample that contains a sparser representation of the positive distribution. For example, as shown in FIG. 2(b), the PU-HDT fails to learn the complete true positive distribution (ideally a half-moon shape) because there is a small region on the left that does not contain any labeled positives that can be exploited to estimate the true positives.

An embodiment of the present invention is the PU Stratified Hellinger Random Forest (PU-SHRF), which may ensure that all labeled positives are represented in each bootstrap sample. Algorithm 2 outlines how PU-SHRF is designed based on PU-HDT and the stratified bootstrap sampling.

Algorithm 2 represents the random forest setup for PU-HDT. Unlike a stand-alone decision tree, Algorithm 2 considers random feature selection when initializing a tree node, wherein ϕ corresponds to the squared root of the number of features |F_{X}|. This is the default option in scikit-learn. Then, a bootstrap sample (X′_{U}, L′_{U}) is obtained from the unlabeled data. The size of the bootstrap sample is defined by K_{U}. The labeled positive instances (X′_{lab}, L′_{lab}) are added to the bootstrap sample (X′_{U}, L′_{U}) to provide the training data (X′, L′) to the PU-HDT. The PU-HDT may be added to the initialized Forest. Algorithm 2 stops when the number t of trees is fitted and added to the Forest. Compared to standard Random Forest, PU-SHRF requires two extra hyperparameters: the size of a stratified bootstrap sample, K_{U} and the class prior, α.

Algorithm 2: PU-SHRF (X, L, t, K_{U}, α)

Input: X - training data, L - labels, t - number of trees, K_{U} size of

bootstrap sample from unlabeled data, α - class prior

| | |
|---|---|
| | Output: Forest - set of t PU Hellinger trees |
| 1 | Initialize Forest |
| 2 | let \| F_{X} \| be the number of features from input X |
| 3 | ϕ ← \sqrt{\| F_{X}\|} |
| 4 | for i ← 1 to t do |
| 5 | \| X_{U}′, L_{U}′ ← BootstrapSamp(Xᵤₙₗ, Lᵤₙₗ, K_{U}) |
| 6 | \| X′ ← X_{U}′ ∪ X_{lab} |
| 7 | \| L′ ← L_{U}′ ∪ L_{lab} |
| 8 | \| Forest ← Forest ∪ PU-HDT (X′, L′, α, ϕ) |
| 9 | end |

Using the embodiments disclosed herein, fraud detection can be performed by applying an HDT to detect fraudulent transactions in a data set of financial transactions (e.g., credit card transactions or insurance transactions). Using a Hellinger distance is part of the applying. The Hellinger distance is used to capture divergence between positive and negative class distribution. An estimated fraud rate can be received at the processor prior to applying the HDT to the data set of financial transactions.

Based on the largest data set, Fraud IEEE, the training of PU-HDT took on average 15.6 seconds across 10 runs. The training set represents around 70% of the data set. The number of examples in the training set is 413378. Moreover, the algorithm took 1.22 seconds on average to provide a score for each instance in the test set (177162 instances). There is no limitation regarding the size of a data set that PU-HDT can process.

A processor can be used to perform this fraud detection. The processor can be part of a computer or a server. The HDT can be part of a machine learning algorithm that runs using the processor. A non-transitory computer readable medium can store the instructions to execute the fraud detection embodiments disclosed herein.

The HDT can be configured to capture divergence between positive and negative class distribution without being dominated by class imbalance. The HDT can be configured to use class prior to estimate counts of positives and negatives in each node.

The size of the HDT can be limited after a tree node reaches a maximum height using the processor. This can avoid overfitting.

The HDT can be a PU-HDT tree. Thus, the data set of fraudulent transactions can be imbalanced positive and unlabeled data.

In an instance, the HDT is used as a base learner in a modified random forest. In this instance, the HDT can be a PU-HDT tree. Thus, the data set of fraudulent transactions can be imbalanced positive and unlabeled data. The HDT can be configured to consider random feature selection when initializing a tree node. The HDT can be configured to use a size of a stratified bootstrap sample and a class prior.

A positive and unlabeled dataset is used to train the HDT. The positive and unlabeled dataset can be unbalanced.

Although the present disclosure has been described with respect to one or more particular embodiments, it will be understood that other embodiments of the present disclosure may be made without departing from the scope of the present disclosure.

The following examples are presented to illustrate the present disclosure. They are not intended to be limiting in any matter.

### Example 1

The following is an example of a “half-moon” dataset providing a comparison of decision boundaries of decision trees, including PU-Hellinger decision tree of Algorithm 1, to illustrate the challenge of learning from positive and unlabeled data in an imbalanced setting. Negative, hidden positives, and positive class data points are included. The areas with darker shading points out more certainty regarding the classification into the positive or negative class. The lighter shading, consequently, implies a higher uncertainty of the classifier. FIG. 2(a) demonstrates the half-moons data set (ground truth); FIG. 2(b) demonstrates the PU-Hellinger Decision Tree on the test set; FIG. 2(c) demonstrates the Hellinger Decision Tree on the test set; and FIG. 2(d) demonstrates the CART on the test set.

This “half-moons” data set consisted of two-dimensional points generated from two interleaved half circles. FIG. 2(a) shows a class-imbalanced variant of the data set in which the class prior α=5%: the upper half-moon corresponds to the negative class, whereas the lower half-moon corresponds to the positive class. Moreover, half of the positives were mislabeled (i.e., unlabeled in the PU setting). The only information on the positive class was the labeled positives, while the rest remained unlabeled.

In this example, three techniques were compared: PU-HDT (FIG. 2(b)), HDT (FIG. 2(c)), and CART (FIG. 2(d)). As shown in FIG. 2(d), the CART decision tree did not learn from PU data, so only a few unlabeled positives fell into the darker regions, and the positive distribution was not well represented by the decision boundary of the CART decision tree. As shown in FIG. 2(c), the HDT performed better because of the built-in insensitivity to the imbalanced setting. However, the algorithm did not learn from positive and unlabeled data. In the region where unlabeled positives dominate (lower left), the HDT provides predictions with high uncertainty. As shown in FIG. 2(b), the PU-HDT learned from PU data and was suitable for the imbalanced setting. Most of the unlabeled positives fell into the darker regions as the technique considered that some positives were unlabeled.

This example shows a clearer representation of the positive distribution that follows a half-moon shape. In this example, the class prior and Hellinger distance are essential and complementary in the method for imbalanced PU classification. One complicating factor in imbalanced classification is data complexity. In a data set that shows high complexity, the few positives cannot represent well enough the minority (positive) class. Techniques that deal with imbalanced data are more robust to the underrepresentation of the minority class. As shown in FIG. 2, HDT provides an advantage over CART. However, the PU setting poses another complicating factor that the Hellinger Distance cannot solve by itself. Some of the unlabeled (i.e., negative) instances are positive. Thus, HDT cannot classify correctly most of the unlabeled positives as such. The class prior allows provides a way to calculate the proportion of the unlabeled positives that need to be considered in the decision tree. Both Hellinger distance and the class prior may be successfully utilized in PU-HDT to enable PU learning in imbalanced data sets.

### Example 2

The following is an example that demonstrates the performance of Algorithm 2 (PU-HDT) as compared to previous techniques. This example shows the classification performance benefit of PU-HDT when applied to imbalanced PU data, such as data sets in which only a small percentage of positive observations is present and only a small percentage of the unlabeled observations would actually be a positive observation if the label were known. In this test, PU-HDT, PU-HRF, and PU-SHRF were compared with twelve previous techniques. Eight techniques came from PU literature. The Hellinger Decision Tree (HDT), Hellinger Random Forest (HRF) and the Stratified Hellinger Random Forest (SHRF) were also included. The evaluation utilized nineteen benchmark data sets. Two evaluation metrics that are commonly used in imbalanced learning were used, namely, the area under the precision recall curve (PR-AUC) and the F1-score, representing the harmonic mean between precision and recall. In contrast to PR-AUC, the F1-score depends on a threshold that might disadvantage techniques that do not provide calibrated scores, such as tree-based methods. Thus, the threshold was optimized according to a validation set to maximize the F1-score for all techniques for each experimental setting. Furthermore, hypothesis testing was applied to statistically validate the empirical results. First, the Iman-Davenport test was applied to determine whether all methods performed the same, as expressed in the null hypothesis. Then, the Holm's post hoc test was used to compare the best performing model with the other techniques.

Nineteen data sets, summarized in Table 1, covering different applications such as churn prediction, fraud detection and image recognition were considered. The churn data sets stemmed from the telecommunications industry. The credit card fraud data set was provided by Wordline and ULB (MLG, 2018) and Fraud IEEE on Kaggle. The car insurance fraud data set was provided by Oracle (Oracle, 2015). Pizza Cutter 1 and Satellite are OpenML data sets (Vanschoren, van Rijn, Bischl, & Torgo, 2013). Forest Cover, Speech, MNIST, Shuttle, Pendigits and Mammography were found in ODDS (Shebuti, 2016). Poker 8 vs 6, Car Good, KDD Cup land-vs-portsweep data sets were available on the KEEL repository (Alcal'a-Fernandez et al., 2011). The Thyroid data set was found in UCI repository (Dua et al., 2019). The selection of the data sets was driven by the goal to compare techniques in a highly imbalanced setting. In previous works, the class imbalance in benchmark data sets was not always extreme, as several data sets show an imbalance ratio below 10. However, this example utilizes an extreme setting by using the most imbalanced data sets on the aforementioned public repositories.

TABLE 1
Summary of data sets

| | | | P |
|---|---|---|---|
| Data Set | Examples | Features | (y = 1) |
| Car Good (CGO) | 1728 | 6 | 3.99% |
| Churn Chile (CCH) | 5263 | 42 | 5.00% |
| Forest Cover (FCO) | 286048 | 10 | 0.96% |
| Fraud Car Insurance (FCI) | 15420 | 30 | 5.98% |
| Fraud Card Credit (FCC) | 282982 | 29 | 0.16% |
| KDDCup land vs portsweep (KDD) | 1061 | 41 | 1.97% |
| Churn Korean (CKO) | 2221 | 8 | 5.00% |
| Mammography (MAM) | 11183 | 6 | 2.32% |
| Pendigits (PEN) | 6870 | 16 | 2.27% |
| Pizza Cutter 1 | 661 | 37 | 7.87% |
| Poker 8 vs 6 (POK) | 1477 | 10 | 1.15% |
| Satellite (SAT) | 5000 | 36 | 1.48% |
| Shuttle (SHU) | 49097 | 9 | 7.15% |
| Thyroid (THY) | 7200 | 21 | 7.41% |
| Yeast 6 (YEA) | 1484 | 8 | 2.35% |
| TV Churn (TVC) | 9379 | 46 | 4.79% |
| Speech (SPE) | 3686 | 400 | 2.35% |
| MNIST (MNI) | 7603 | 100 | 9.21% |
| Fraud IEEE (FIE) | 590540 | 251 | 3.50% |

To create the PU data, some positives were flipped completely at random (i.e., SCAR) into unlabeled observations in each of the data sets. In the experiments, the number of labeled positives was determined by the flip ratio, which is the proportion of positives to be unlabeled. Three values of the flip ratio were considered: 25, 50, and 75%. For each experimental setting, 20 repetitions of a holdout validation were performed to split the data into a training set (70%) and test set (30%) with a different random seed. The large number of repetitions was needed because training from imbalanced PU data might lead to unstable performance. For the data sets that contained more than 10,000 examples, 10,000 observations were sampled without replacement to be used in each repetition in order to limit the computation time of the experiments. In total, there were 1140 settings (19 datasets×20 repetitions×3 flip ratios) in the experiments where the class prior estimate equals the ground truth. For the sensitivity analysis, there are 1900 settings (19 datasets×20 repetitions×5 class prior estimates).

The PU Hellinger-based techniques were compared to eight well-known PU learning techniques: imbalanced nonnegative PU learning (imbalanced nnPU) (Su et al., 2021), nonnegative PU learning (nnPU) (Kiryo et al., 2017), unbiased PU learning (uPU) (Du Plessis et al., 2015), PU Bagging (Mordelet & Vert, 2014), Rank Pruning (Northcutt, Wu, & Chuang, 2017), PU Weighted Logistic Regression (Lee & Liu, 2003), Elkan-Noto's method, that is, the preprocessing method using label probabilities (Elkan & Noto, 2008), and Spy-EM (Liu et al., 2002). The test also included four non-PU baselines: Random Forest (Breiman, 2001) combined with ADASYN (He et al., 2008), HDT (Cieslak & Chawla, 2008), and its ensemble-based HRF and SURF.

Table 2 summarizes the hyperparameter configurations of the methods in the experimental setup. PU learning methods in the experimental setup required hyperparameters that need to be specified by the end-user. However, there are suggested values for most of the hyper-parameters that have shown good results in previous experiments. For the PU Hellinger-based techniques and unbiased PU learning, along with its extensions, it was determined the class prior is an essential hyperparameter, as it enables the labeled positives to be weighted to enable PU learning. In this example, it is assumed that the class prior is known at training time. In practice, the class prior can be estimated using several methods from. Another important hyperparameter for PU-SHRF is K_{U}, which is the number of unlabeled examples in each bootstrap. PU Bagging also uses K_{U}, but it subsamples the unlabeled examples to balance the training data and to avoid sample contamination by hidden positives. PU-SHRF can increase the number of unlabeled examples in the bootstrap samples because it can naturally address class imbalance and PU data. Thus, K_{U}=U_{training} was opted as the default value, which lead to stratified bootstrap samples for each PU Hellinger tree in the ensemble. For the PU-HDT and HDT, the max depth of the tree was set to 5 to avoid overfitting. Rank pruning, PU-weighted logistic regression, Elkan-Noto's method and Spy-EM followed the hyperparameters recommended by the authors. The remainder of the hyperparameters were set to the default values in scikit-learn.

TABLE 2
Experimental hyperparameters

| Technique | Setting |
|---|---|
| PU-SHRF | K_{U} = U_{training}, trees = 100, α = α_{groundtruth} |
| PU-HRF | trees = 100, α = α_{groundtruth} |
| ADASYN + | neighbors = 5, sampling strategy = |
| Random Forest | balanced ratio, trees = 100 |
| PU-HDT | max depth = 5, α = α_{groundtruth} |
| HDT | max depth = 5 |
| uPU | base learner = XGBoost |
| nnPU | base learner = XGBoost, α = α_{groundtruth} |
| imbalanced uPU | base learner = XGBoost, α = α_{groundtruth} |
| PU Bagging | hyperparameters recommended |
| | by authors |
| Rank Pruning | hyperparameters recommended |
| | by authors |
| PU Weighted | hyperparameters recommended |
| Logistic | by authors |
| Regression | |
| Elkan-Noto's | hyperparameters recommended |
| Method | by authors |
| Spy-EM | hyperparameters recommended |
| | by authors |
| HDT | max depth = 5 |
| HRF | trees = 100 |
| SHRF | K_{U} = U_{training}, trees = 100 |

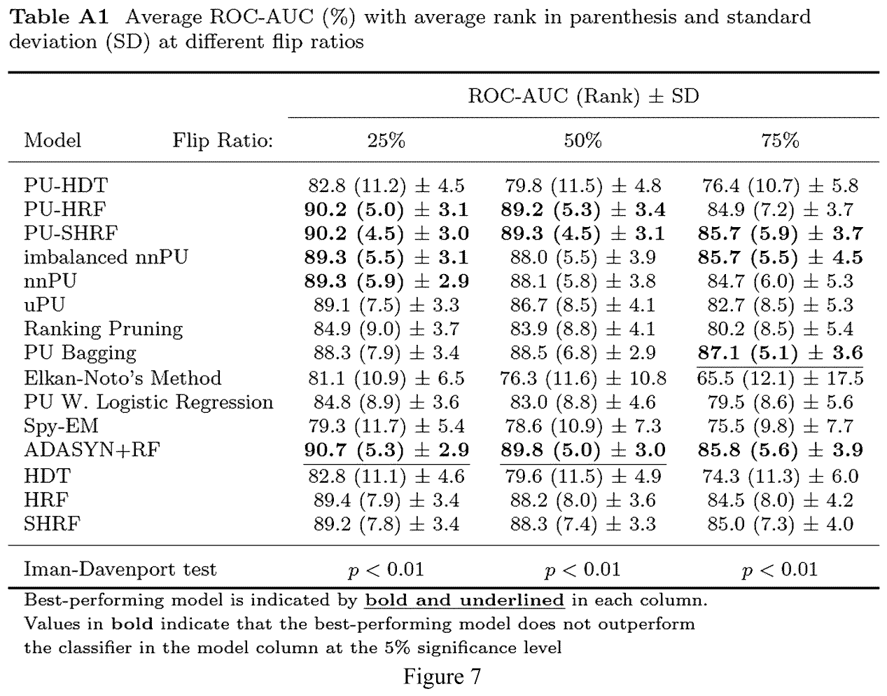

The average and standard deviation of the F1-score and PR-AUC are shown Tables 3 and 4. The average rank is included in parenthesis. The average F1-score and PR-AUC per data set is reported in the appendix. Additionally, results on the ROC-AUC are presented in Table A1 in FIG. 7. The bold and underlined value indicates the best performing model for a given flip ratio. Based on the average rank of each technique's metrics over all data sets, the Iman-Davenport test rejects the null hypothesis that all methods perform equally (p<0.01). Furthermore, the Holm's post hoc test was applied to identify the sources of the differences in performance. The best-performing model was used as the control classifier in the pairwise comparison with all other models.

PU-SHRF and PU-HRF outperformed all of the other techniques in terms of the F1-score with the optimized threshold. Furthermore, the Holm's post hoc test was implemented to further validate that PU-SHRF and PU-HRF statistically outperform the other techniques at the 5% significance level. The uPU, nnPU and imbalanced nnPU, considered to be state-of-the-art in the literature, generally perform better than earlier PU methods. Moreover, the benefit of using imbalanced nnPU, designed for imbalanced data sets, over nnPU was observed. It was determined that imbalanced nnPU performed better than nnPU at every flip ratio. PU Bagging remained as a competitive alternative at the highest flip ratio. A possible explanation is that PU Bagging naturally handles the class imbalance because each of the bootstrap samples consists of a balanced subset of the training data. The fact that the techniques for imbalanced classification such as ADASYN+Random Forest and HRF outperform most of the PU methods emphasizes the weakness of conventional PU methods for imbalanced classification.

In terms of PR-AUC, HRF stood out as the best technique at every flip ratio. However, PU-SHRF was not outperformed with statistical significance at 5%. Similarly, PU-HRF was not outperformed with statistical significance at 5% when the flip ratio is either 25% or 50%. The other competitor PU method that was not statistically outperformed was imbalanced nnPU at 75%. Despite the good performance in terms of F1-score and ROC-AUC, PU Bagging performed poorly with respect to PR-AUC. This may suggest that the balanced bootstrap improved recall at the expense of precision. Furthermore, the use of a traditional data-level method for handling class imbalance together with a standard classifier, for instance ADASYN+Random Forest, was a good alternative that outperformed older PU techniques. Based on the results in Table 4, it was observed that techniques that natively handle class imbalance perform well in terms of PR-AUC.

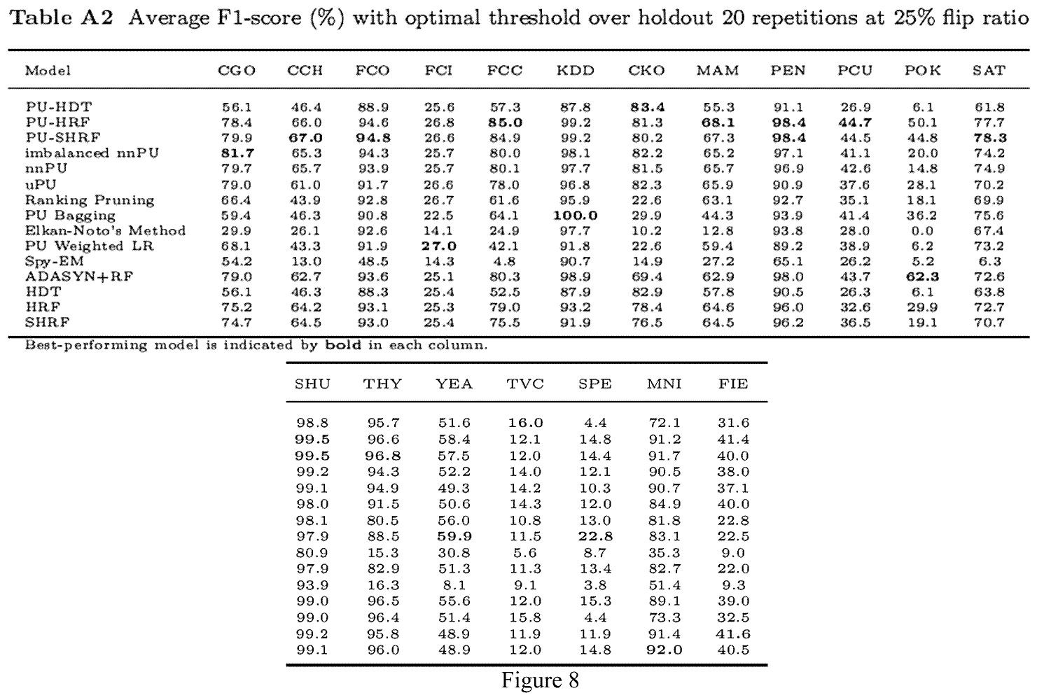

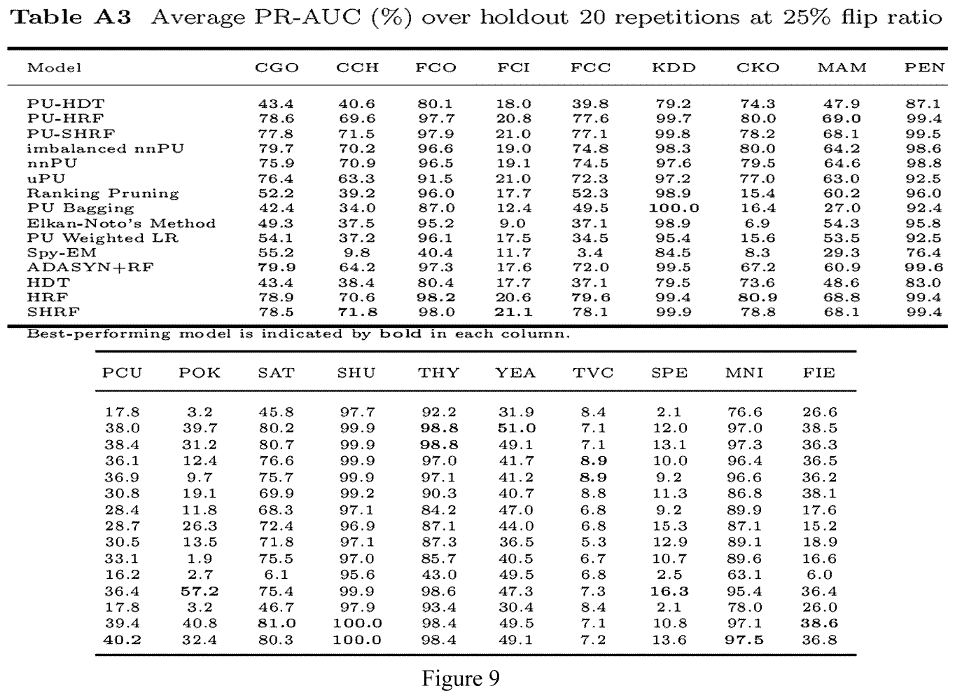

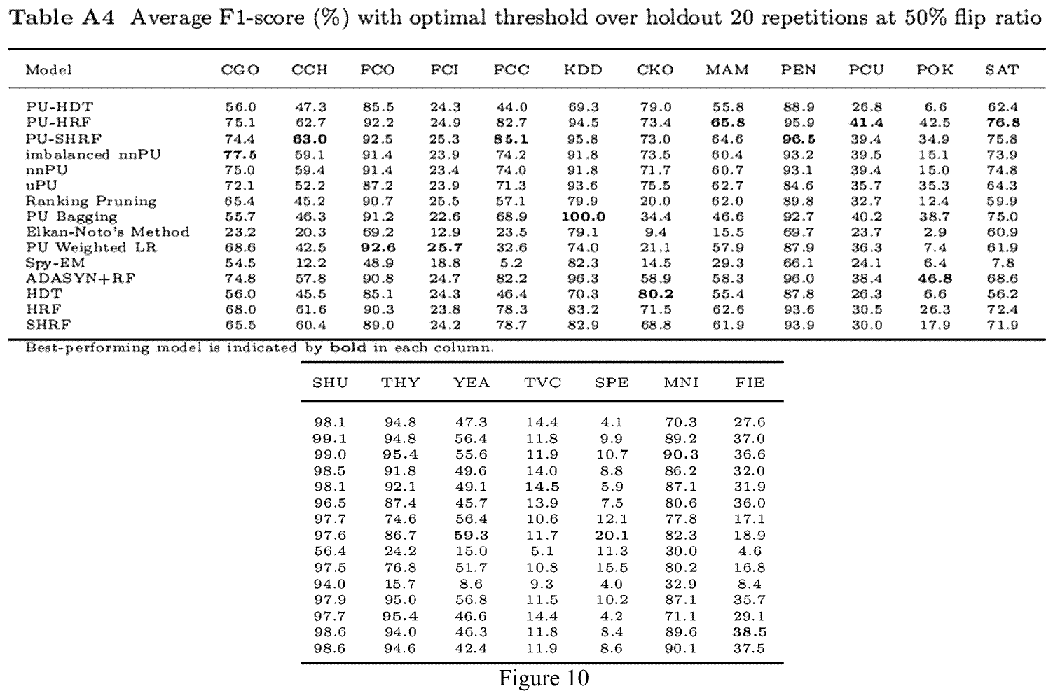

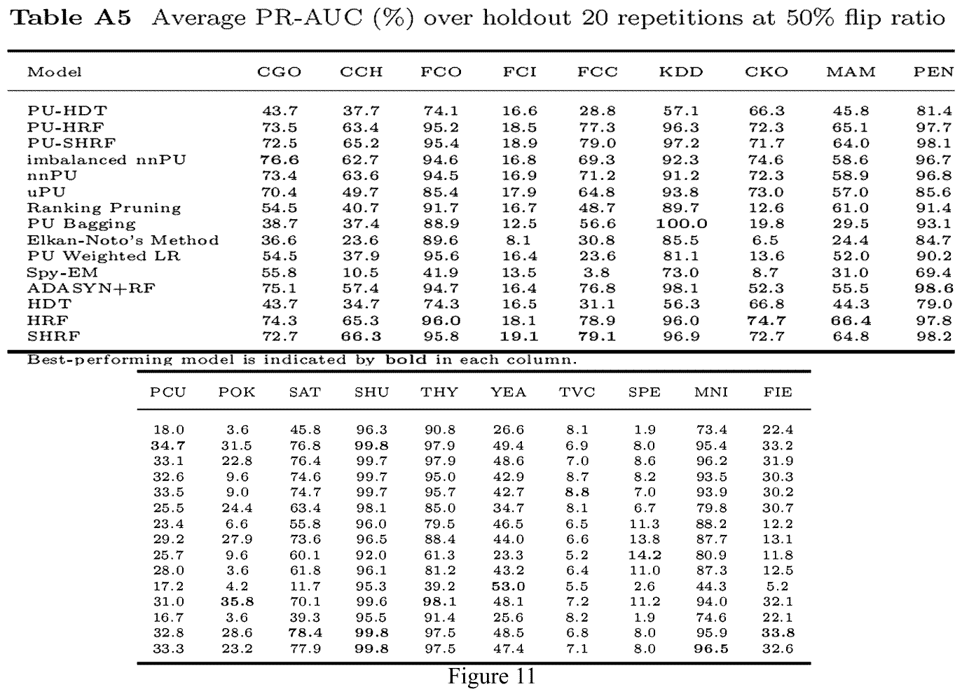

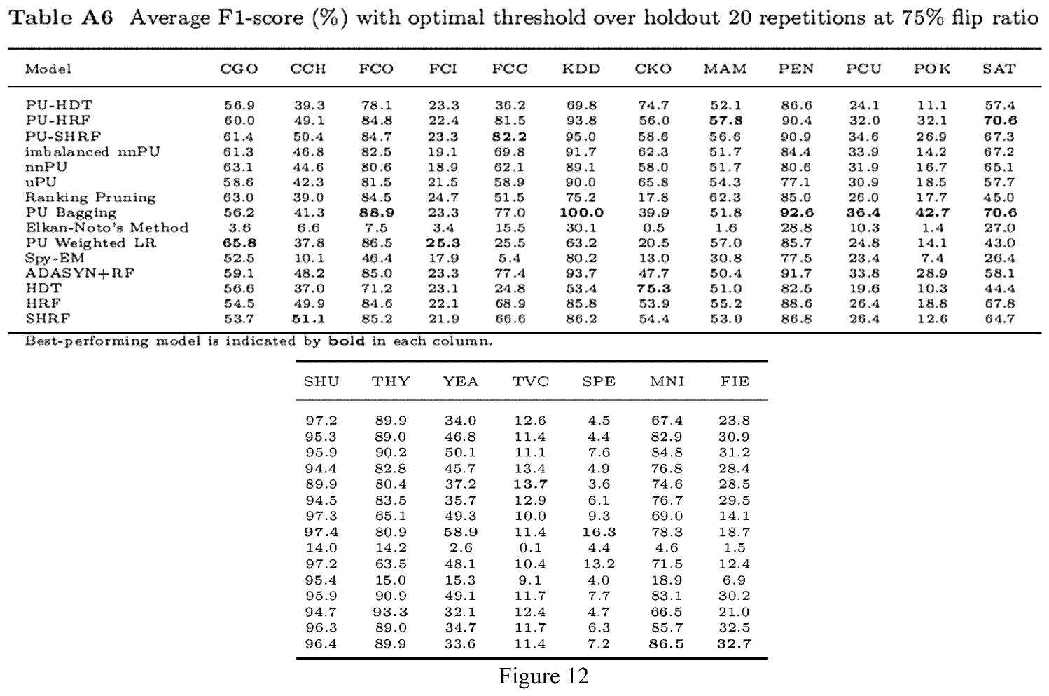

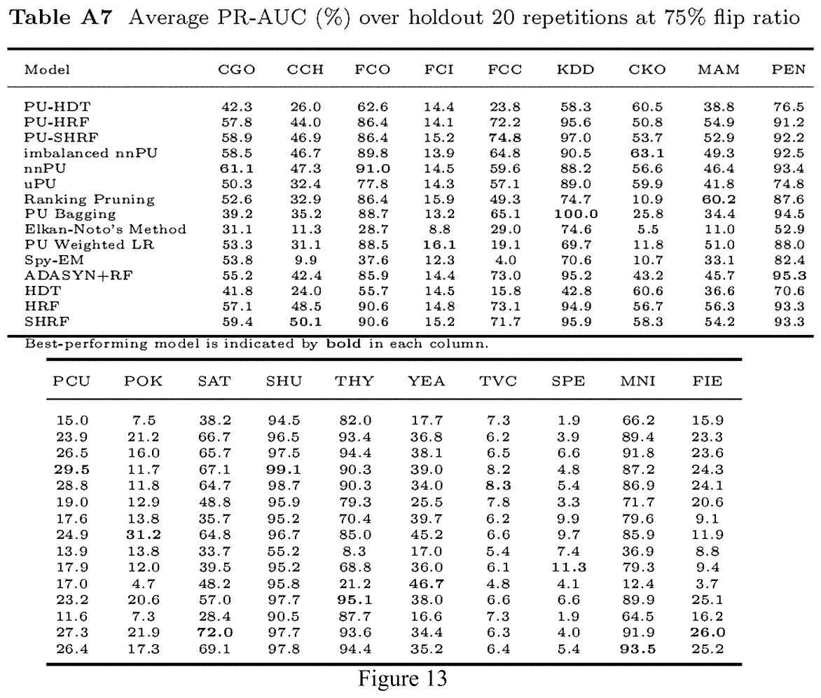

The results per data set also give more insights about the techniques' performance. Table A2, A4, and A6 (FIGS. 8, 10, 12) present the average F1-score per data set at different flip ratios. Table A3, A5, and A7 (FIGS. 9, 11, 13) contain the average PR-AUC for each data set at different flip ratios. The best performing technique remains consistent at low and medium flip ratios in most data sets. In the PEN data set, PU-SHRF outperformed all other techniques in F1-score, except for the setting with the high flip ratio where PU bagging dominates. This might explain why PU bagging became a competitive alternative to the methods of the present invention in the aggregate results (Table 3) at the high flip ratio. Moreover, PU-HRF and PU-SHRF showed strong performance in both F1-score and PR-AUC as compared to other PU methods. In FCC, the most imbalanced data set, PU-HRF and PU-SHRF substantially outperformed the PU techniques.

From the empirical analysis, some general insights were derived that highlight the advantages of PU-SHRF and PU-HRF. PU classification under high class imbalance poses a challenge to most PU methods. Despite not being able to learn from PU data, a resampling strategy might be sufficient to outperform most PU methods. The PU methods that perform well in imbalanced data sets are those that have integrated a specialized mechanism that diminishes the bias towards the majority class. Imbalanced nnPU incorporates oversampling in the risk minimization, whereas PU Bagging exploits balanced bootstrap sampling. However, each of these strategies achieves either better recall (i.e., ROC-AUC or F1-score) or better precision (i.e., PR-AUC). It was also observed that HRF and SHRF are competitive techniques for imbalanced learning, particularly in precision related metrics such as PR-AUC. The PU methods of the present invention (PU-SHRF and PU-HRF) allows reaching a state-of-the-art performance because it combines a better mechanism to retrieve unlabeled positives and the robustness of Hellinger distance for imbalanced learning. Furthermore, a tailored bootstrap sampling that guarantees that the positive instances are always considered may help to improve the performance under a high flip ratio.

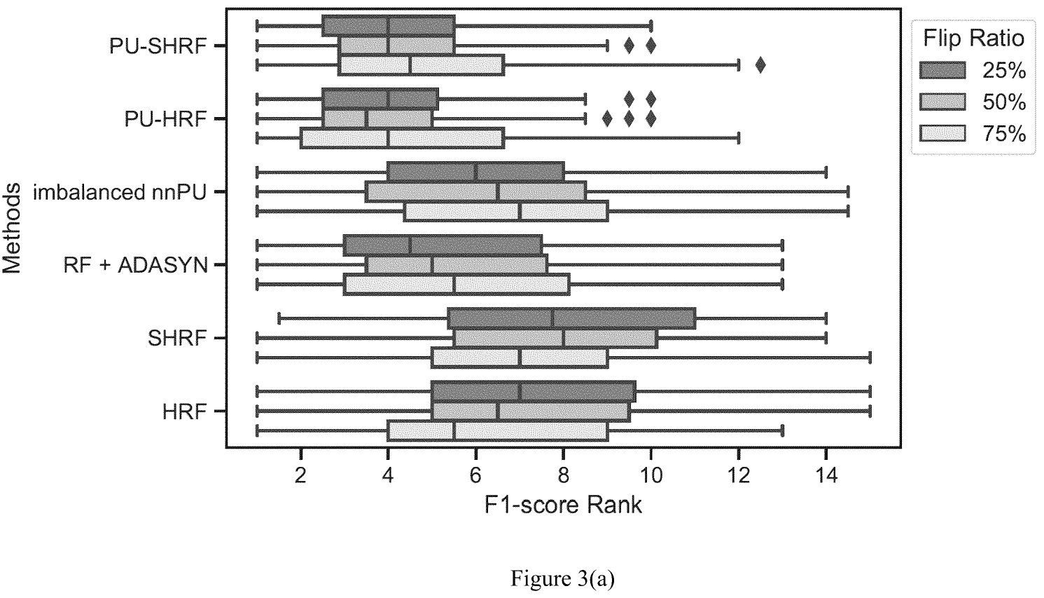

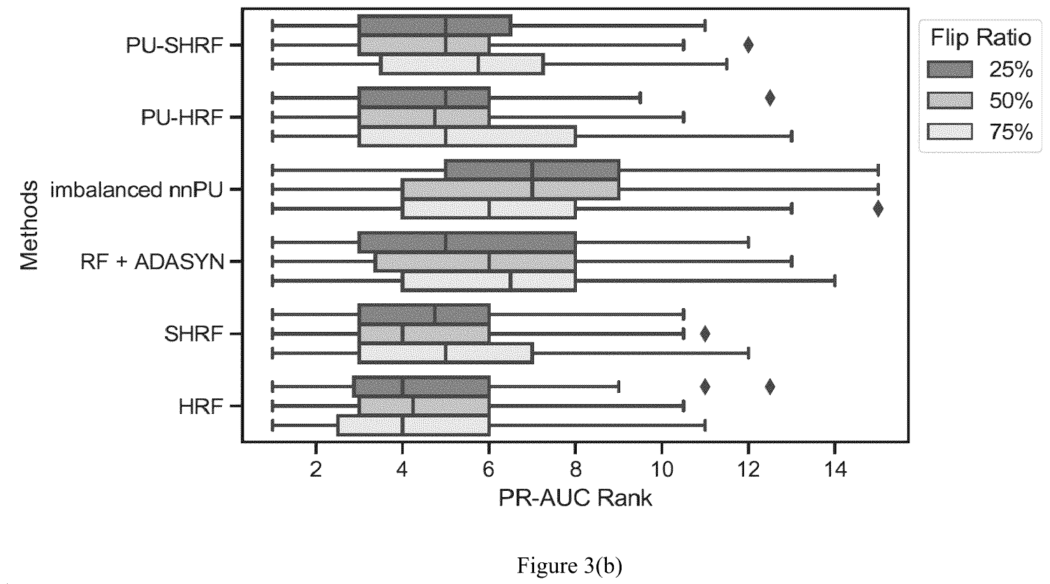

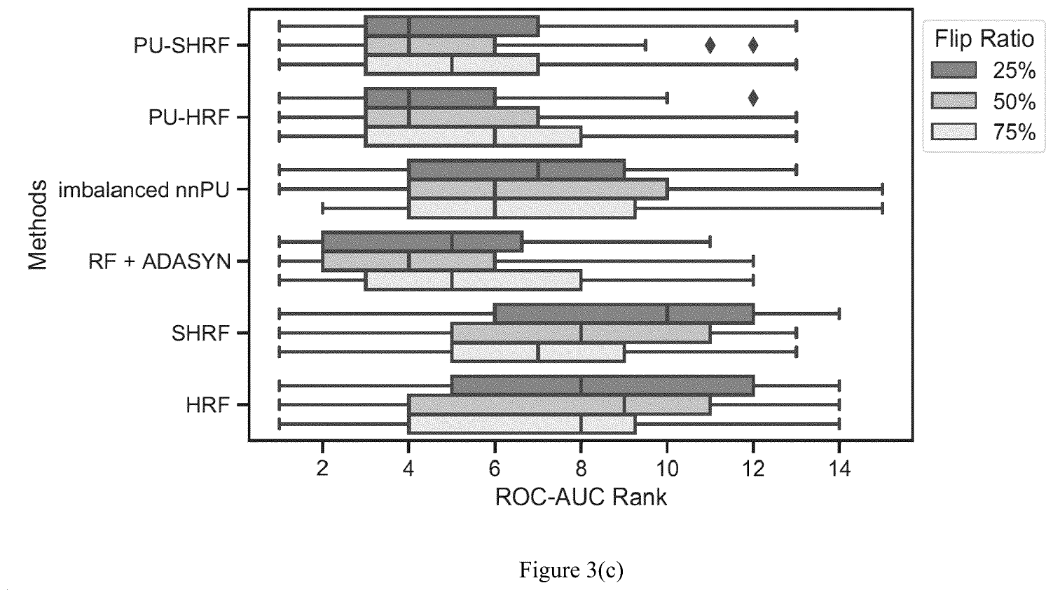

FIG. 3 displays a comparison of F1-score with optimal threshold, PR-AUC, and ROC-AUC ranks across different flip ratios in the top five imbalanced data sets. This analysis presents more granular results for data sets with the highest class imbalance. This analysis focused on the scenario where the underrepresentation of the minority class was severe, such as when the scenario relates to applications such as fraud detection and medical diagnosis. Besides the PU Methods disclosed herein, HRF, SHRF, ADASYN+RF and imbalanced nnPU were considered in the analysis based on the performance described above. Furthermore, five data sets were selected that displayed the highest class imbalance; FCC, FCO, POK, SAT, and KDD. FIG. 3 visualizes the rank of each metric to emphasize the relative performance between methods.

FIG. 3(a) demonstrates that the PU methods disclosed herein present a better median rank than other methods across all flip ratios. Furthermore, it can be observed that the PU methods disclosed herein show less variability in the F1-score ranks compared to the rest of the competitors. In contrast to the aggregated results, RF+ADASYN seems to dominate imbalanced nnPU for the high dimensional data sets. In FIG. 3(b), SHRF and HRF maintain a slight advantage over the PU methods disclosed herein. PU-SHRF and PU-HRF present a better median rank than RF+ADASYN and imbalanced nnPU. The overall strong performance in PR-AUC of the Hellinger-based methods in the top imbalanced data sets provides evidence in line with previous studies regarding the effectiveness of the Hellinger distance on extremely imbalanced data sets. Lastly, in FIG. 3(c), PU-SHRF, PU-HRF, and RF+ADASYN perform similarly and outperform the other methods. At low and medium flip ratio, the PU methods disclosed herein outperform the other competitors, except for RF+ADASYN, in median rank.

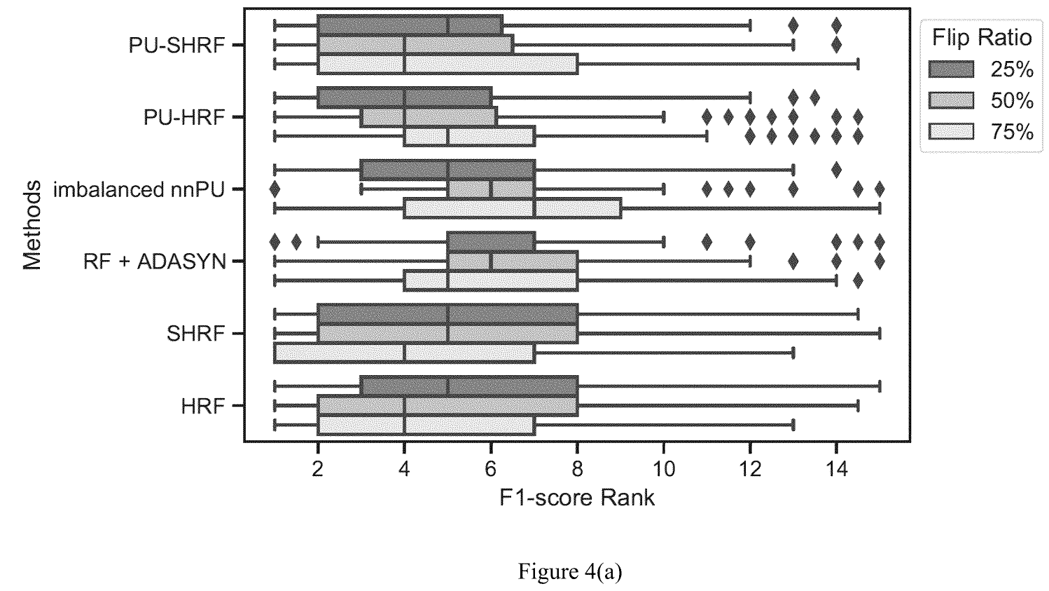

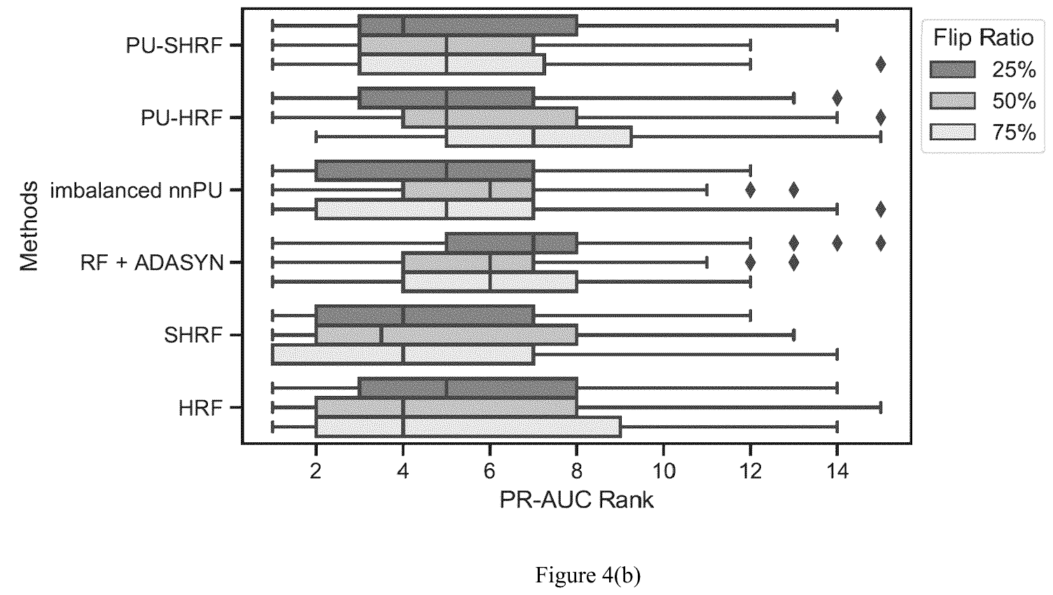

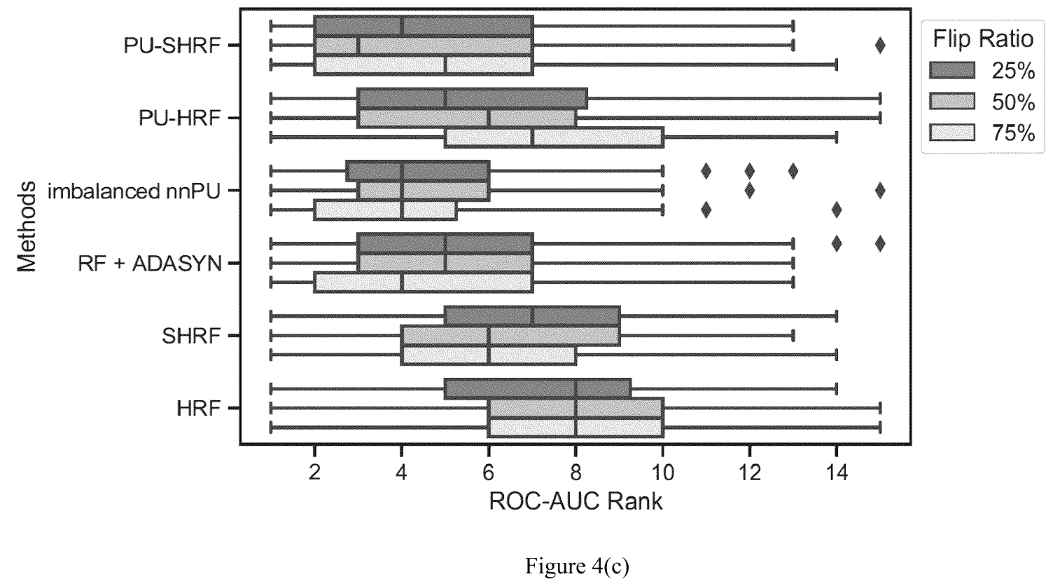

FIG. 4 displays a comparison of F1-score with optimal threshold, PR-AUC, and ROC-AUC ranks across different flop ratios in the top five high dimensional data sets. This figure displays the results for data sets with the highest number of features. Given that the PU methods disclosed herein are based on the random forest algorithm, a high number of irrelevant features may negatively affect the methods' performance. The methods described above were used in this analysis. Furthermore, the following data sets containing the highest number of features were selected: SPE, FIE, MNI, TVC, and CCH. FIG. 4 also visualizes the rank of F1-score, ROC-AUC, and PR-AUC.

As shown in FIG. 4(a), the PU methods disclosed herein perform slightly better than imbalanced nnPU and RF+ADASYN. However, a large overlap between the disclosed methods with SHRF and HRF in F1-score and PR-AUC was observed. Moreover, PU-SHRF and HRF present smaller variability in ranks than SHRF and HRF. As shown in FIG. 4(b), SHRF and HRF maintain a slight advantage over our PU methods. PU-SHRF shows a better median rank than RF+ADASYN and imbalanced nnPU across the flip ratios. However, RF+ADASYN obtains the smallest interquartile range (IQR), whereas SHRF and HRF suffer from the largest IQR. As shown in FIG. 4(c), PU-SHRF and PU-HRF outperform SHRF and HRF, accordingly. Moreover, PU-SHRF reaches the best median rank at low and medium flip ratio. Nevertheless, imbalanced nnPU and RF+ADASYN dominate at high flip ratio. Imbalanced nnPU does not outperform the rest of the methods despite using XGBoost as its classifier. In the positive-negative setting, boosting is more robust to high dimensional data sets than bagging-based techniques. However, under the PU setting, bagging often shows a better ensemble strategy as it is more robust to overfitting.

In this example, a sensitivity analysis on class prior was estimated. The accurate estimation of the class prior is important for most of the state-of-the-art PU methods. The tree-based methods disclosed herein exploit the class prior to incorporate unlabeled positives into the node split. On the one hand, an underestimated class prior may lead to insufficient retrieval of unlabeled positives for the learning task. On the other hand, an overestimation of the class prior can consistently create more false positives because an excessive number of unlabeled instances are regarded as positives. Several studies have proposed techniques to provide an estimate of the class prior under the SCAR assumption. This example opted for a sensitivity analysis to measure the change in performance when the class prior is wrongly estimated. The sensitivity analysis focuses on the SCAR setting with a 50% flip ratio to represent a scenario in which half of the positives are mislabeled. Similar to other evaluations in this example, imbalanced nnPU, PU-HDT, PU-HRF and PU-SHRF were selected for the sensitivity analysis. Different values of the class prior estimate were utilized based on the ground-truth class prior α. The sensitivity analysis includes five values for the class prior estimate \hat{α}∈{0.25α, 0.50α, α, 2α, 4α}. The analysis was performed per data set with 20 repetitions for each experimental setting.

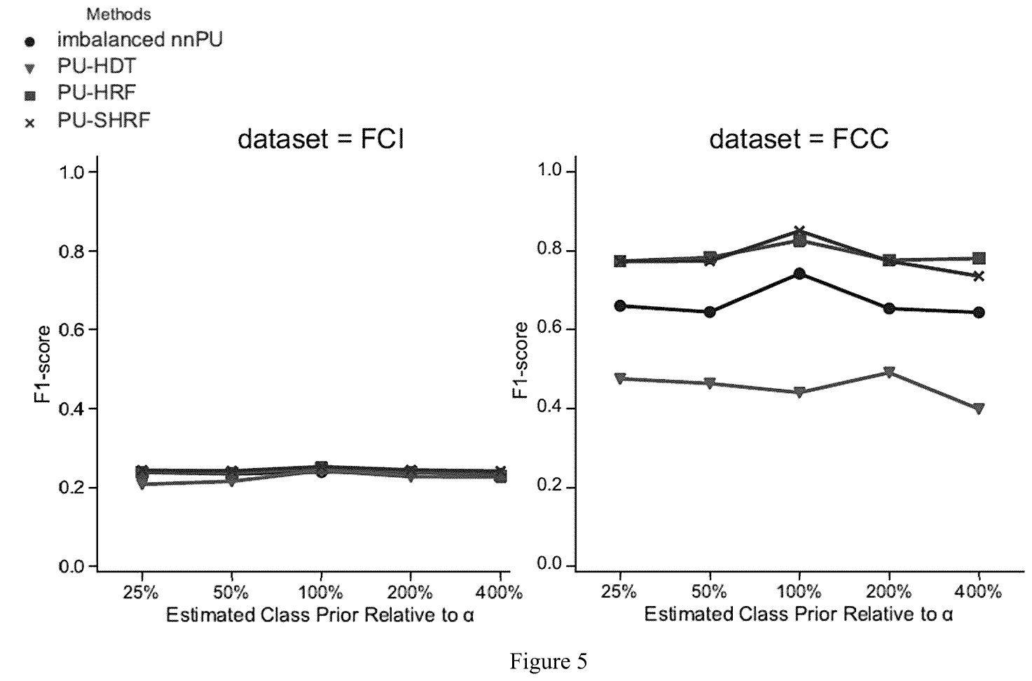

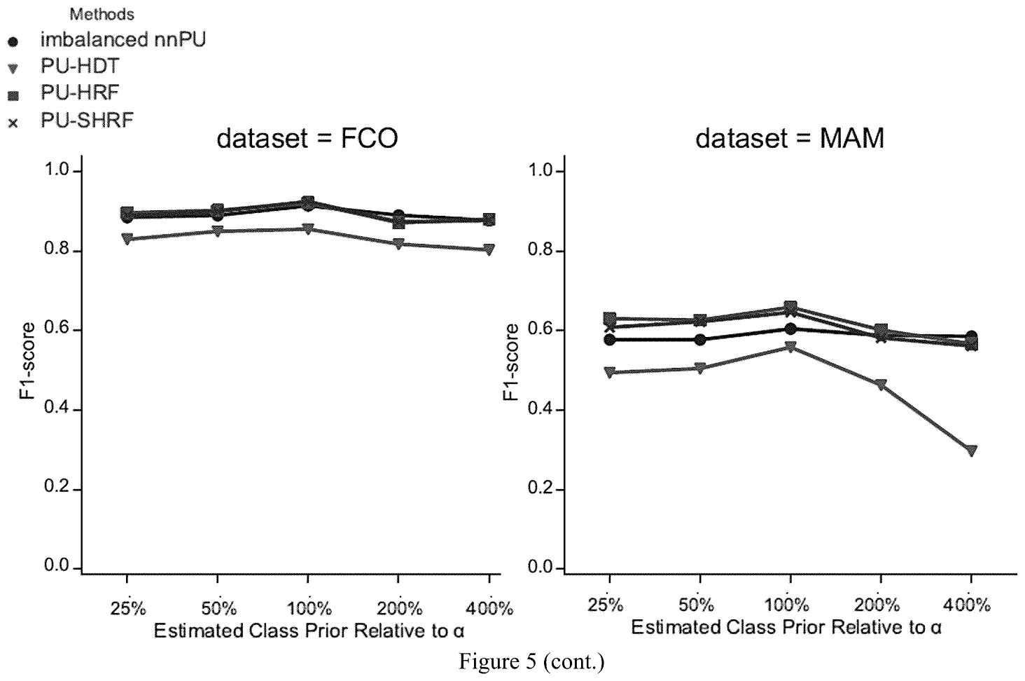

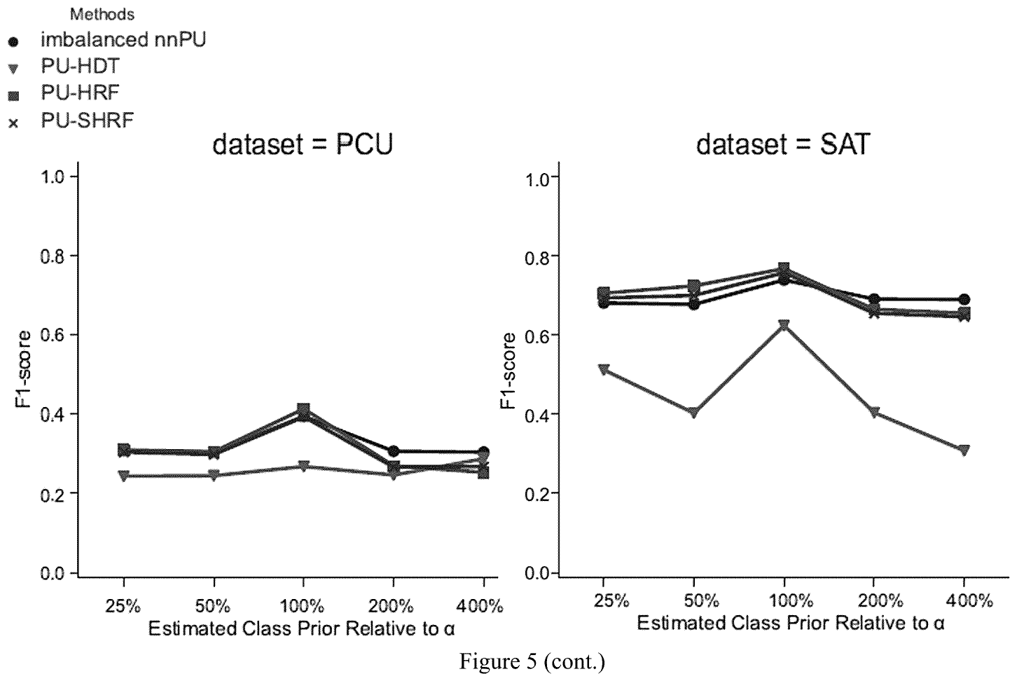

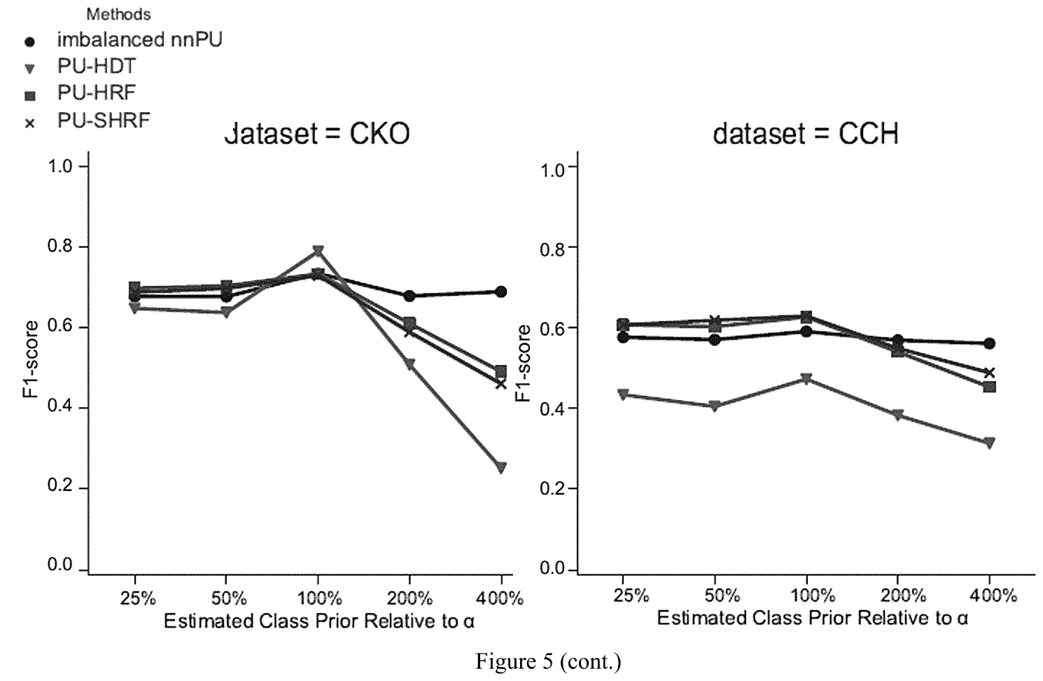

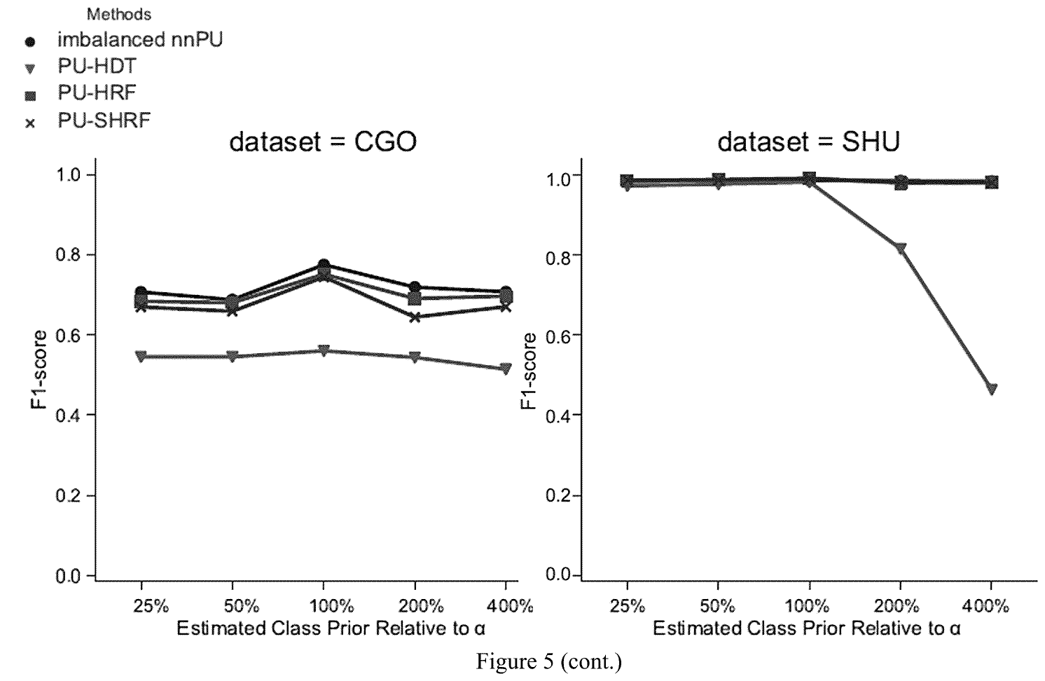

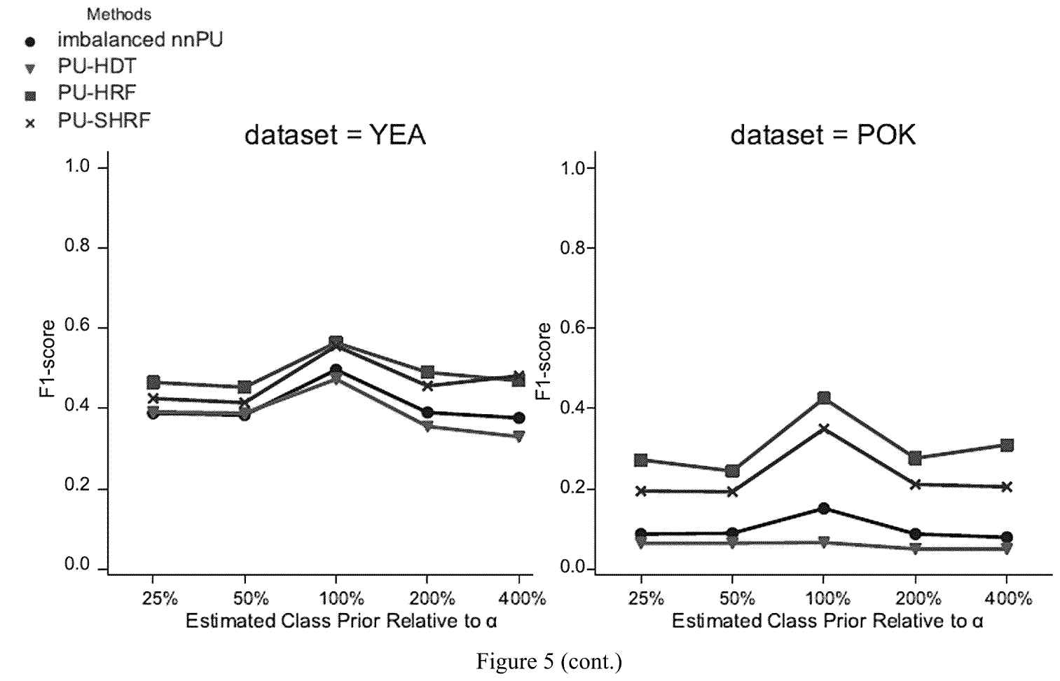

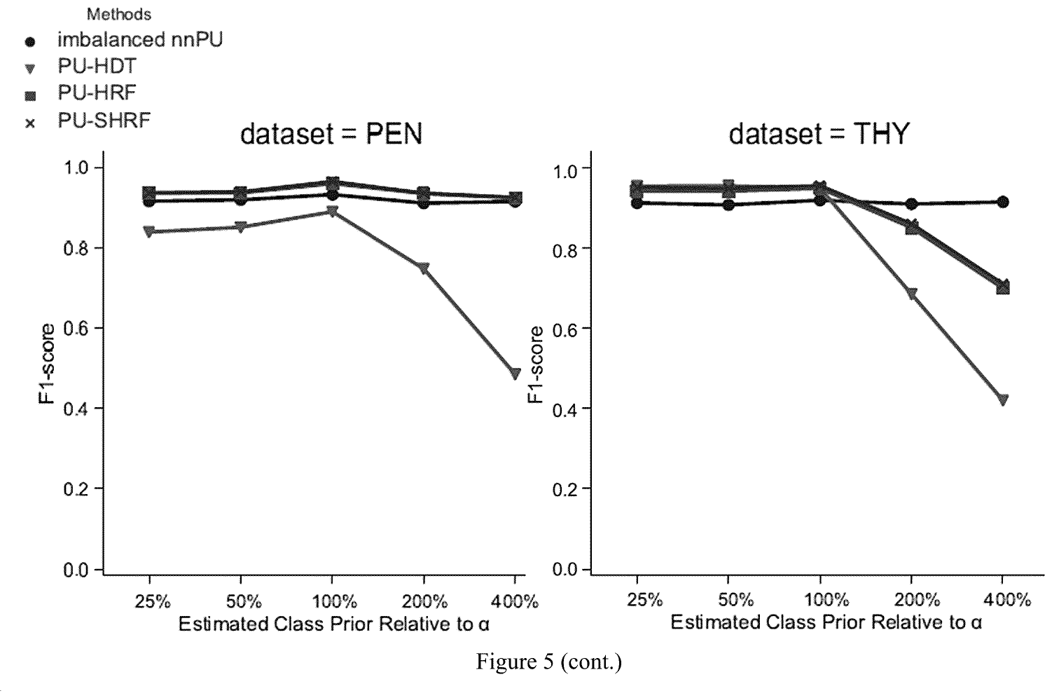

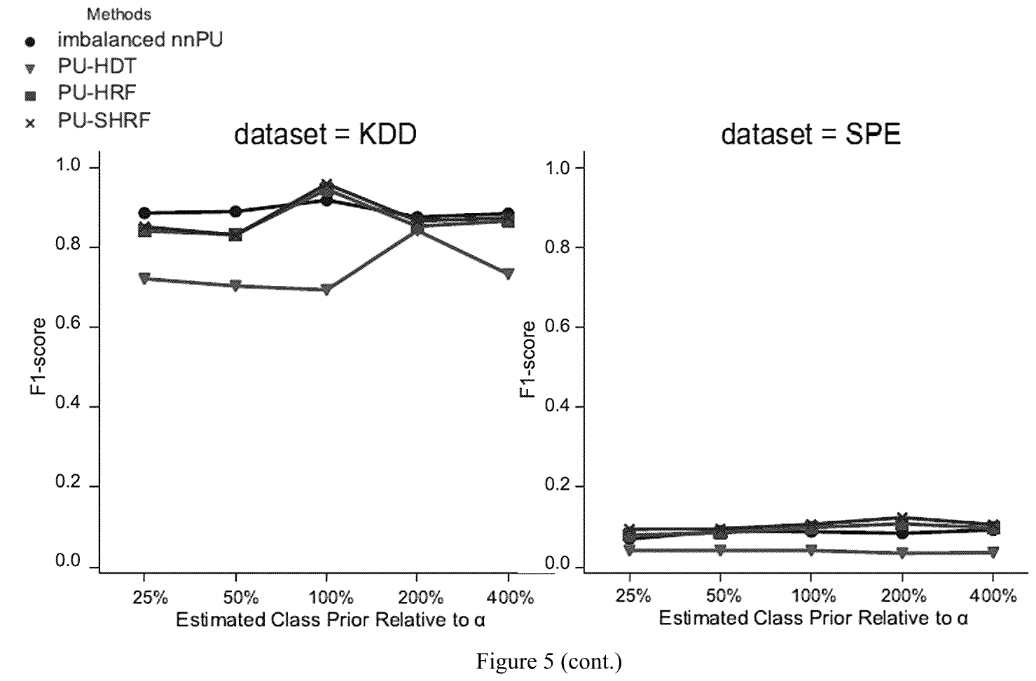

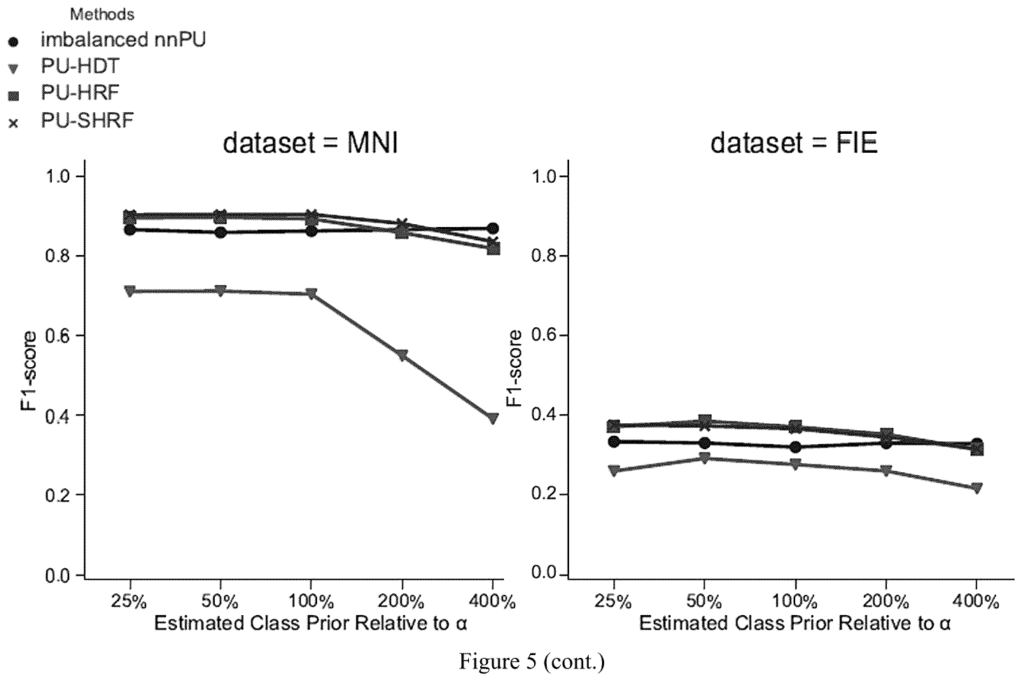

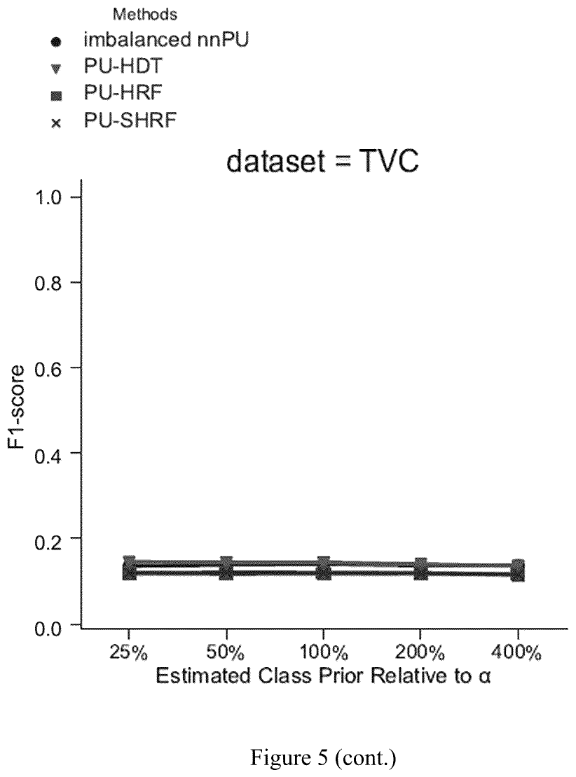

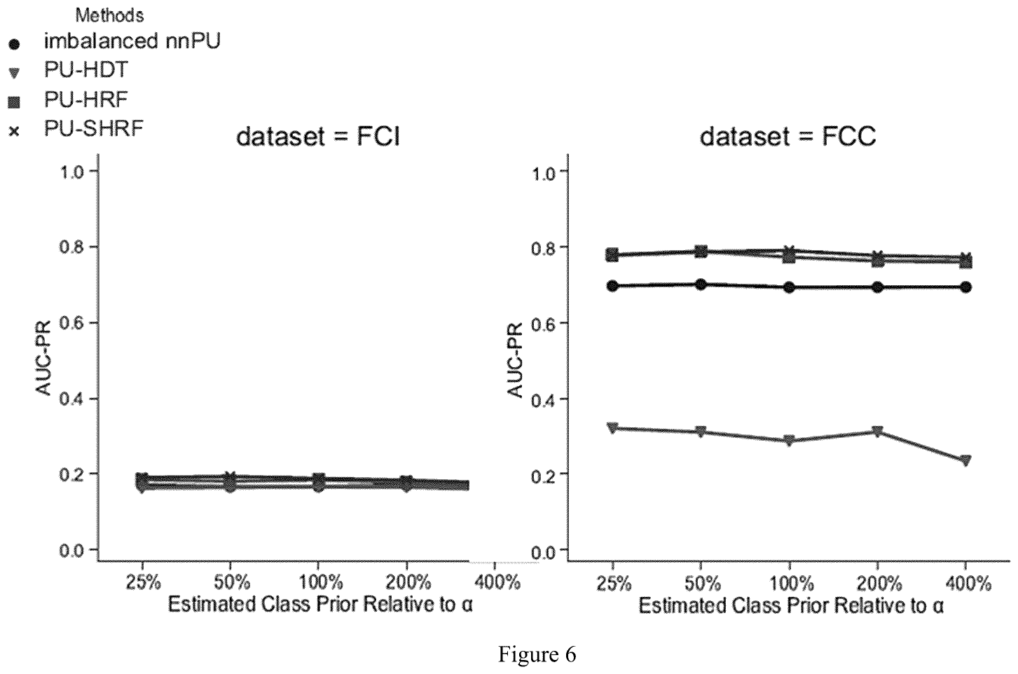

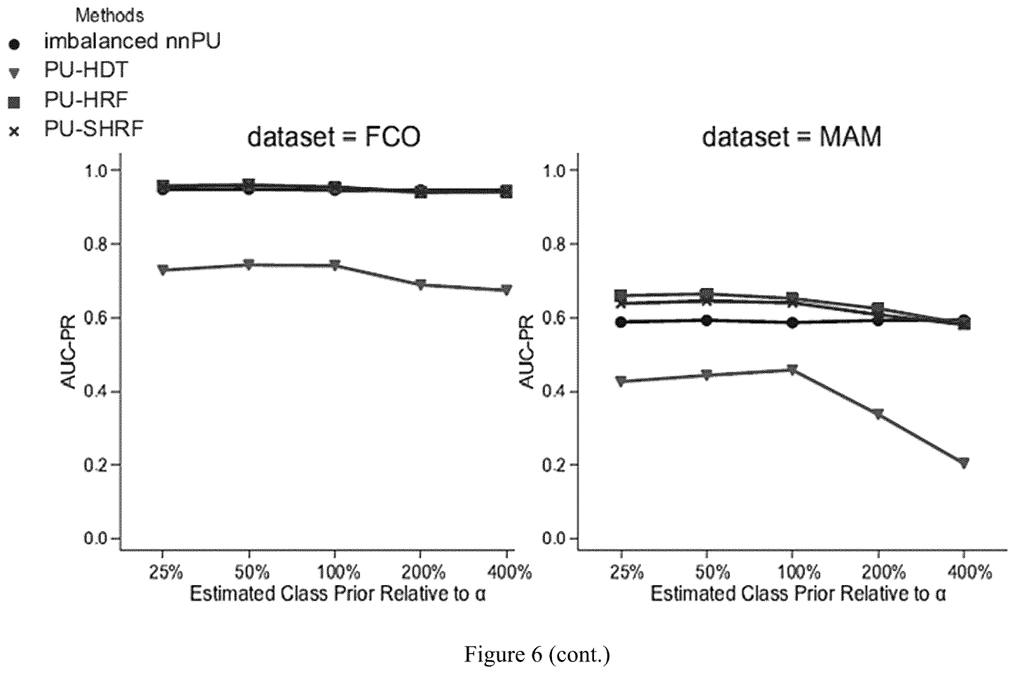

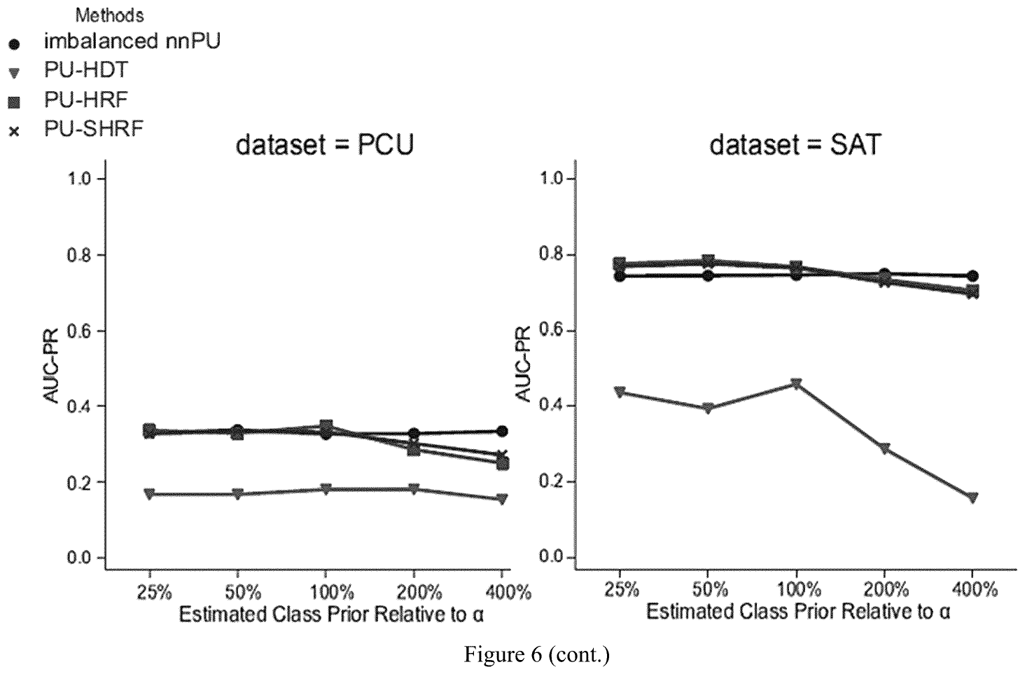

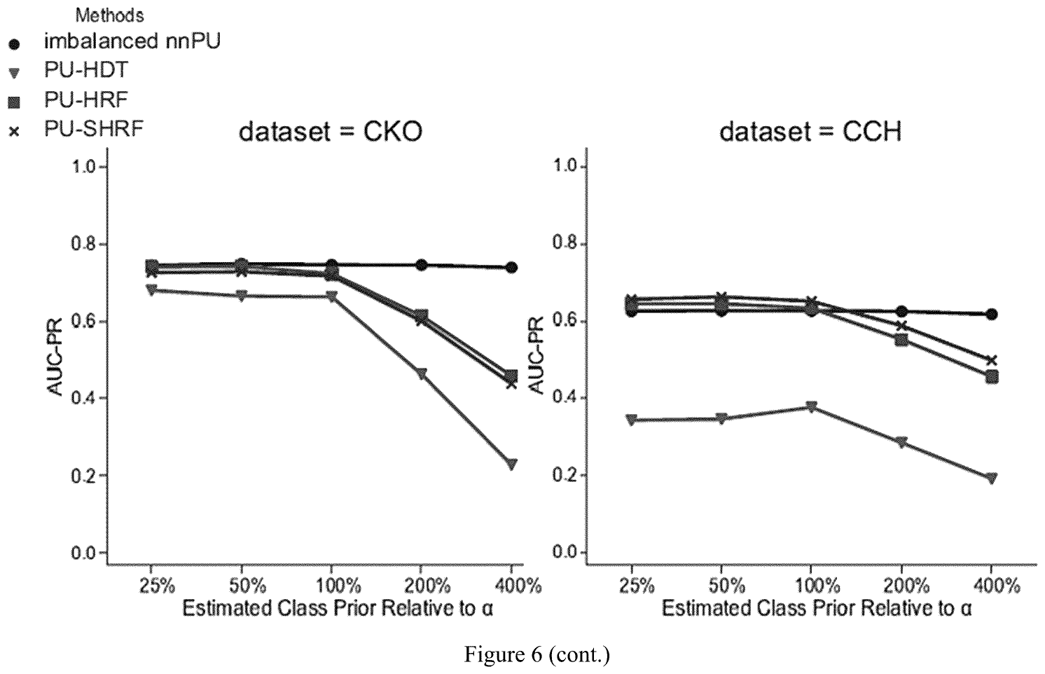

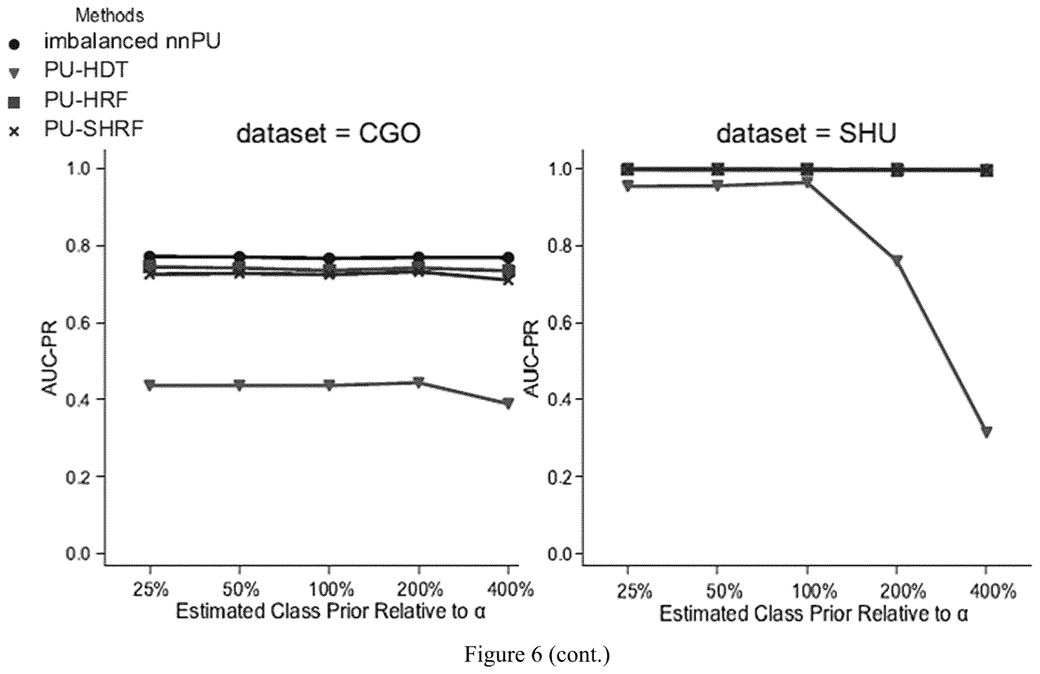

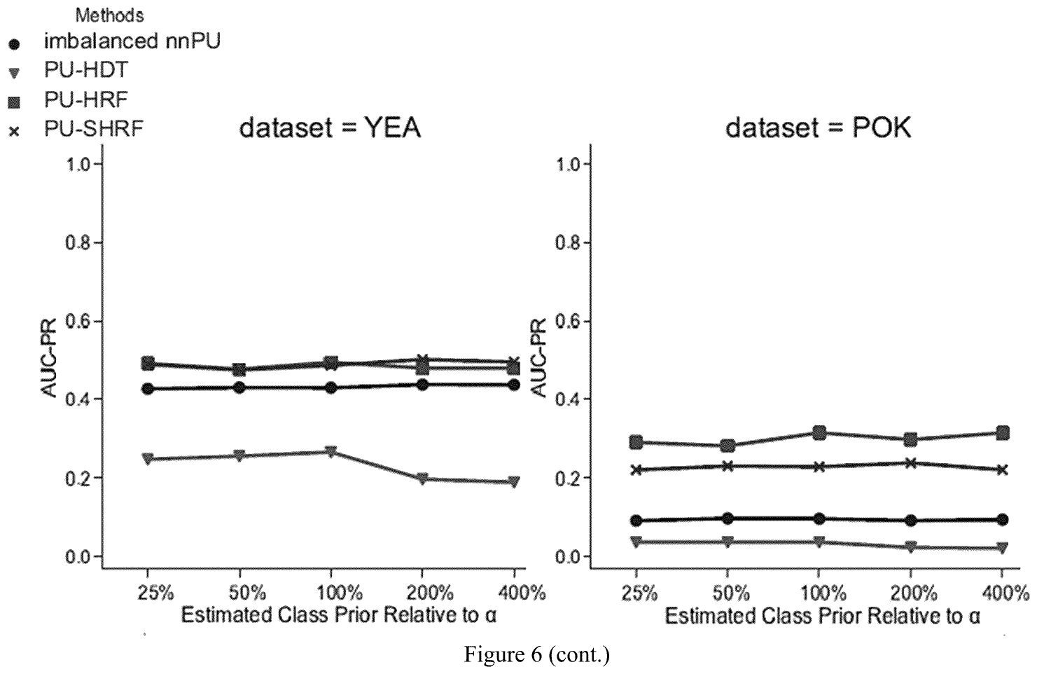

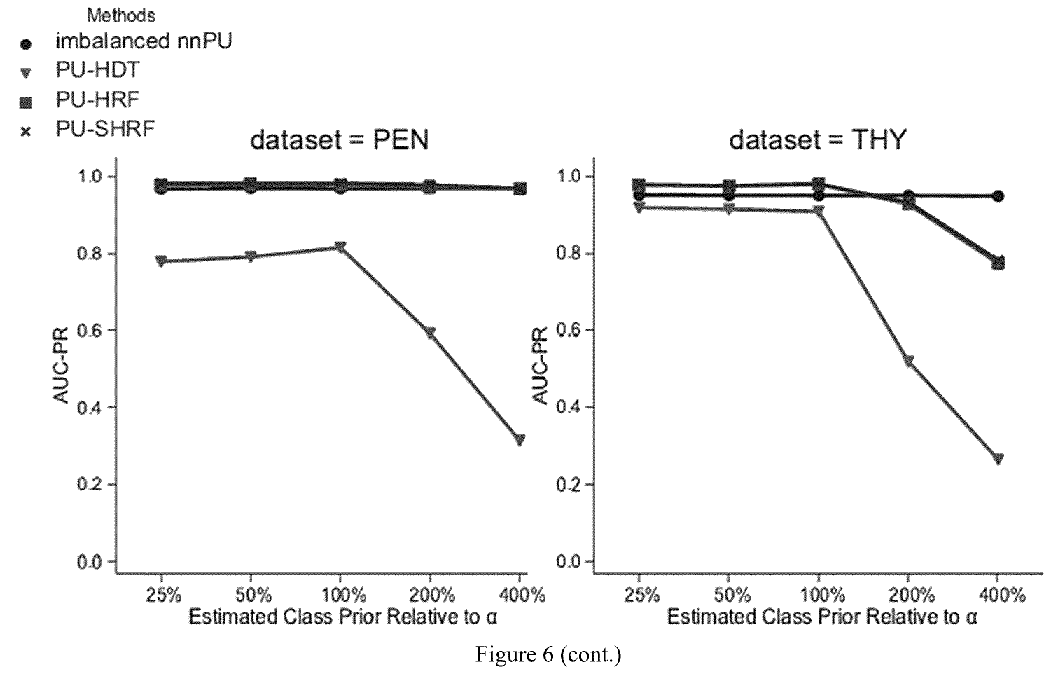

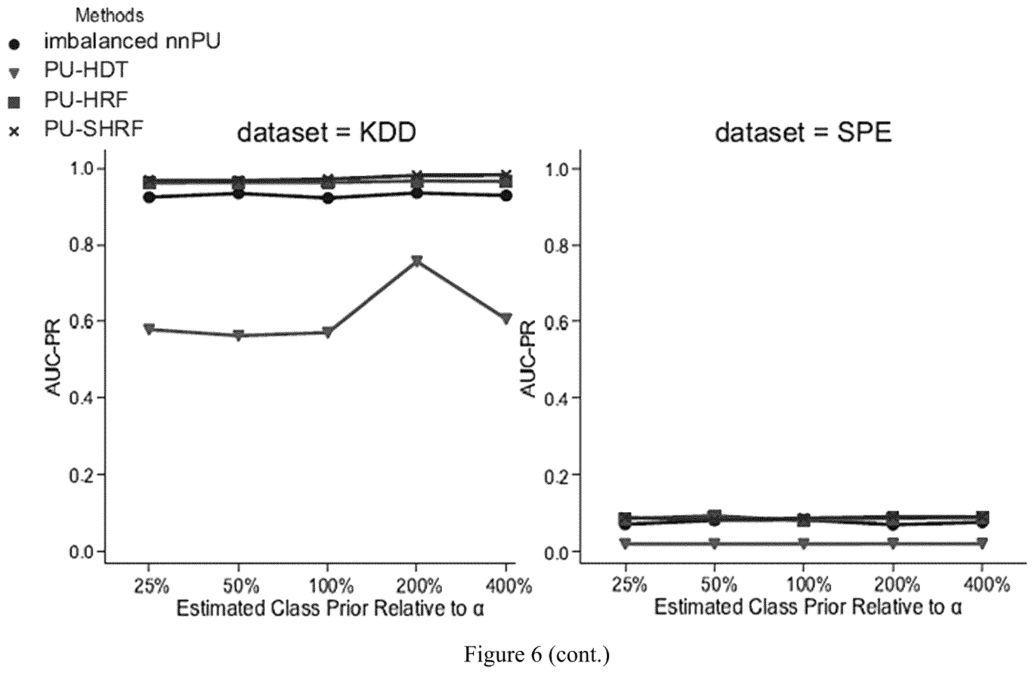

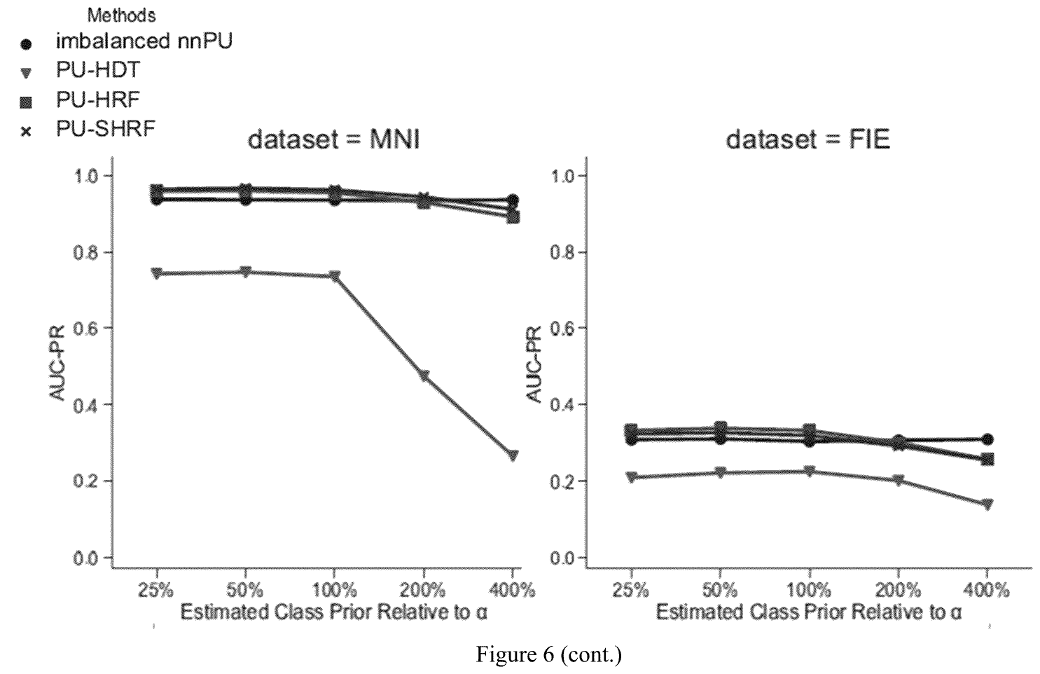

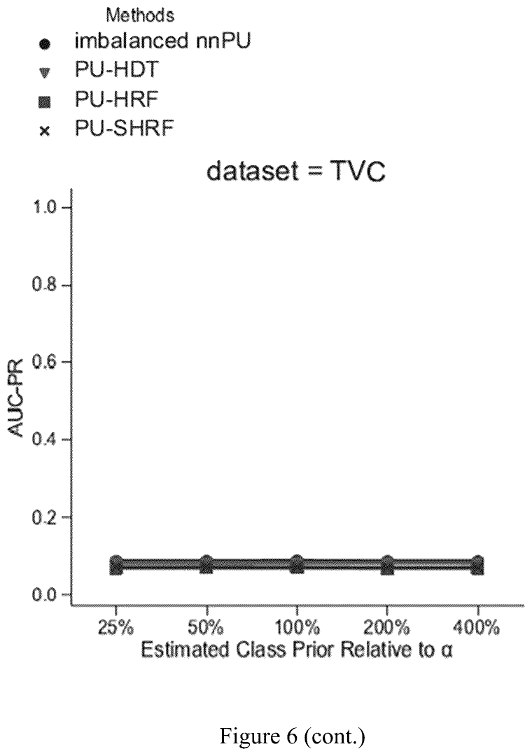

FIG. 5 and FIG. 6 present the results of the sensitivity analysis. Among the selected PU methods, imbalanced nnPU seems to be the most robust to a wrong class prior estimate. The robustness of (imbalanced) nnPU in this experiment confirms previous results. Due to the modified PU loss function that prevents a negative empirical risk, nnPU offers a stronger robustness as compared to uPU.

FIG. 5 displays the average F1-score (%) with optimal threshold per data set at 50% flip ration across different class prior estimated. Each experimental setting was repeated 20 times. As shown in FIG. 5 on F1-score, in some data sets (e.g., FCC, MAM, PCU, CGO, YEA, POK, KDD), the algorithms presented herein present a “hat” pattern with a peak in performance when the estimated class prior is the ground truth. The pattern is more extreme in PU-HDT as compared to PU-HRF and PU-SHRF. Thus, the ensemble-based methods disclosed herein should be preferred over PU-HDT due to stronger robustness to a wrong class prior estimate. Despite an average lower F1-score, imbalanced nnPU shows a smoother “hat” pattern which relates to a smaller drop in performance when the class prior is wrongly estimated. The overestimation of the class prior can be more harmful to the PU methods disclosed herein than the imbalanced nnPU.

FIG. 6 displays the average PR-AUC (%) per data set at 50% flip ration across different class prior estimates. Each experimental setting was repeated 20 times. As shown in FIG. 6 on PR-AUC, the PU methods disclosed herein shows that in some data sets there is a stronger weakness to overestimation than underestimation. This pattern is more noticeable in PCU, CKO, CCH, and THY. For PU-HDT, the drop in performance is larger than the ensemble-based PU methods when the class prior is overestimated. Intuitively, overestimating the class prior leads to more false positives in the method's learning.

The PU learning technique disclosed herein has the ability to handle highly imbalanced data sets: PU Hellinger Decision Tree (PU-HDT). PU-HDT utilizes the Hellinger distance as the splitting criterion, which shows robustness to extreme class imbalance. Furthermore, PU-HDT may learn from PU data by means of the estimation of positives from unlabeled instances at each node of the tree. Unlike other PU methods for imbalanced learning, the PU-HDT does not entail additional misclassification costs or require a resampling strategy.

By using PU-HDT as the base learner, an aspect of the invention disclosed is the PU Hellinger Stratified Random Forest (PU-SHRF). The empirical analysis suggests that PU-SHRF generally outperforms all well-known PU methods under all experimental settings. Techniques for imbalanced learning can outperform state-of-the-art PU methods without an adaptation for imbalanced data sets. Statistical hypothesis testing is applied to further validate the empirical findings. Furthermore, this example considered the sensitivity analysis regarding the class prior estimate. It was shown that PU-SHRF and PU-HRF are more robust to PU-HDT to a wrong class prior estimate. Nevertheless, the class prior may need to be sufficiently well-estimated.

It was assumed that labeled positives represented a random subset of the positive class. This scenario referred to the SCAR assumption. However, the SCAR assumption does not hold in most real-world applications. Thus, this example could be extended to accommodate more realistic assumptions. Imbalanced data streams also can be analyzed with respect to this scenario.

### Example 3

The following is an example of Hellinger decision trees for fraud detection implementing the machine learning algorithms disclosed herein.

Hellinger trees can provide added value to many fraud detection applications. The invention disclosed herein includes algorithmic properties that allows state-of-the-art performance in fraud detection.

This technique provides robustness to class imbalance. Hellinger distance has shown strong theoretical robustness to extreme degrees of class imbalance in previous studies. FIG. 2 which is based on the half-moon data set in scikit-learn, shows the benefit of the Hellinger distance under the imbalanced PU setting. Half of the positives are shown as negative (i.e., unlabeled) to the algorithms. It can be observed that Hellinger-based decision trees can better learn the actual half-moon patterns of the data set compared to the standard CART.

This technique provides capability for PU learning. Hellinger trees can easily adapt to PU learning as long as the end-user can provide an estimated fraud rate. FIG. 2 displays a comparison of decision boundaries of decision trees, including PU-Hellinger decision tree, to illustrate the challenge of learning from positive and unlabeled data in an imbalanced setting. Negative, hidden positive, and positive class are represented. The areas with a darker shading point out more certainty regarding the classification into the positive or negative class. The lighter shading, consequently, implies a higher uncertainty of the classifier. Specifically, FIG. 2 shows the improvement of adding information on the fraud rate to the Hellinger decision tree. Compared to the vanilla Hellinger decision tree, the PU-Hellinger decision tree identifies correctly most of the hidden fraudsters shown in FIG. 2(b) as they fall into the darker shaded region of the decision boundaries.

This technique is robust to overfitting under PU setting. Hellinger trees can be utilized as the base learner for a Random-Forest setup. One benefit of the random forest compared to modern boosting-based algorithms (e.g., XGBoost) is that bagging-based methods are less prone to overfitting in settings with inaccurate or incomplete label information. Algorithms that suffer from overfitting can rapidly lose predictive performance over time as fraud evolves to avoid detection systems.

In this example, experiments were conducted with open-source fraud detection data sets to evaluate the performance of the PU Hellinger trees. Fraud detection is particularly challenging due to the high-class imbalance. Most fraud data sets contain less than 10% of fraudulent cases. The first data set (FCC) is provided by Wordline and ULB on Kaggle. The data set contains transactions made by credit cards in September 2013 by European cardholders. This dataset presents transactions that occurred in two days, where we have 282982 transactions with 0.16% of fraudulent cases. The second data set (FIE) comes from an IEEE-CIS research competition held on Kaggle sponsored by Vesta Corporation. This data set contains 590540 online transactions with 5.98% of fraudulent cases. The last data set (FCI) comes from car insurance fraud detection, given by Oracle. The data set contains 15420 car insurance claims between 1994 and 1996 from an undisclosed insurance company. The data sets are depicted in Table 5.

TABLE 5
Summary of data sets

| Data set | Examples | Features | Fraud Rate |
|---|---|---|---|
| Fraud Card Credit (FCC) | 282982 | 29 | 0.16% |
| Fraud IEEE (FIE) | 590540 | 251 | 3.50% |
| Fraud Car Insurance (FCI) | 15420 | 30 | 5.98% |

To create the PU data, some positives were flipped completely at random into unlabeled observations in each of the data sets. In the experiments, the number of labeled positives was determined by the flip ratio, which is the proportion of positives to be unlabeled. Three values of the flip ratio are considered: 25%, 50%, and 75%. For each data set, 20 repetitions of a holdout validation were performed to split the data into a training set (70%) and test set (30%). In the case that a procedure required parameter tuning, training set was split into two equal sets to obtain a validation set.

In the results of this example, two previous techniques were included in the comparison: imbalanced nnPU and ADASYN+Random Forest (ADASYN+RF). The method imbalanced nnPU represents state-of-the-art performance in imbalanced PU classification. In this example, imbalanced nnPU utilized XGBoost as the wrapper method. This example also included a Random Forest that trains from a re-balanced data by ADASYN. Resampling methods are among the most popular solutions to imbalanced learning tasks. Moreover, the Hellinger-tree-based algorithms disclosed are included. PU Hellinger Decision Tree (PU-HDT) is a stand-alone decision tree that utilizes Hellinger distance as the split criterion instead of Gini or Entropy as in scikit-learn. PU Hellinger Random Forest and PU Stratified Hellinger Random Forest are two ensemble methods that use PU-HDT as the base learner. The difference between PU-SHRF and PU-HRF is that the former implements a stratified bagging so the positives (fraudulent) instances are always included in the training of each of the base learners.

For the Fraud Credit Card (FCC) data set, PU-HRF and PU-SHRF were observed to outperform state-of-the-art imbalanced nnPU and ADASYN+RF in most experimental settings. For medium and high flip ratio, PU-SHRF benefits from the stratified bagging so that its performance is better than PU-HRF. Intuitively, the stratified bagging becomes more relevant when fewer and fewer positive examples are available for training. The higher the flip ratio, the fewer positives are available. Also, ADASYN helps to improve the performance of the Random Forest which surpasses the XGBoost-based imbalanced nnPU.

For the Fraud IEEE (FIE) data set, PU-HRF and PU-SHRF were observed to outperform state-of-the-art imbalanced nnPU and ADASYN+RF in most experimental settings. However, an exception occurred in the high flip ratio setting where ADASYN+RF reached the best PR-AUC performance. For high flip ratio, PU-SHRF benefitted from the stratified bagging so that its performance is better than PU-HRF. As in the previous paragraph, ADASYN+RF outperforms the XGBoost-based imbalanced nnPU.

For the Fraud Car Insurance (FCI) data set, PU-HRF and PU-SHRF outperform state-of-the-art imbalanced nnPU and ADASYN+RF in most experimental settings. In the high flip ratio setting, three methods have identical F1-score performance: PU-HDT, PU-SHRF, and ADASYN+RF. As shown herein, PU-SHRF excels at extreme settings where fraudulent examples are scarce.

What is claimed is:

1. A method of fraud detection comprising:
receiving, at a processor, a data set of financial transactions; and
applying a Hellinger decision tree, using the processor, to detect fraudulent transactions in the data set of financial transactions whereby using a Hellinger distance is part of the applying.

2. The method of claim 1, wherein the Hellinger decision tree is part of a machine learning algorithm.

3. The method of claim 1, wherein the Hellinger decision tree is configured to capture divergence between positive and negative class distribution without being dominated by class imbalance.

4. The method of claim 1, wherein the Hellinger decision tree is configured to use class prior to estimate counts of positives and negatives in each node.

5. The method of claim 1, further comprising limiting a size of the Hellinger decision tree after a tree node reaches a maximum height using the processor thereby avoiding overfitting.

6. The method of claim 1, wherein the Hellinger decision tree is a positive and unbalanced Hellinger decision tree, and wherein the data set of fraudulent transactions is imbalanced positive and unlabeled data.

7. The method of claim 1, further comprising receiving an estimated fraud rate at the processor prior to the applying.

8. The method of claim 1, wherein the Hellinger decision tree is used as a base learner in a modified random forest.

9. The method of claim 8, wherein the Hellinger decision tree is a positive and unbalanced Hellinger decision tree, and wherein the data set of fraudulent transactions is imbalanced positive and unlabeled data.

10. The method of claim 9, wherein the Hellinger decision tree is configured to consider random feature selection when initializing a tree node.

11. The method of claim 9, wherein the Hellinger decision tree is configured to use a size of a stratified bootstrap sample and a class prior.

12. The method of claim 1, wherein the Hellinger distance is used to capture divergence between positive and negative class distribution.

13. The method of claim 1, further comprising:
receiving a positive and unlabeled dataset at the processor; and
training the Hellinger decision tree with the positive and unlabeled dataset.

14. The method of claim 13, wherein the positive and unlabeled dataset is unbalanced.

15. The method of claim 1, wherein the financial transactions are credit card transactions.

16. The method of claim 1, wherein the financial transactions are insurance transactions.

17. A system configured to perform the method of claim 1, wherein the system is a computer or a server.

18. A non-transitory computer readable medium storing a program configured to instruct the processor to execute the method of claim 1.
